(19) United States
(12) Patent Application Publication
(10) Pub. No.: US 2013/0290172 A1
(43) Pub. Date: Oct. 31, 2013

(54) SYSTEM AND METHOD FOR CROWDSOURCING, SELECTING, TRANSACTING GIFTS AND FINANCIAL DISCOUNTS IN PHYSICAL STORES AND E-COMMERCE ENVIRONMENTS

(71) Applicant: Alex Mashinsky, New York, NY (US)

(72) Inventor: Alex Mashinsky, New York, NY (US)

(21) Appl. No.: 13/772,312

(22) Filed: Feb. 20, 2013

Related U.S. Application Data
(63) Continuation-in-part of application No. 12/086,723, filed on Jun. 18, 2008.
Application No. 12/086,723 is a continuation-in-part of application No. 10/594,264, filed on Apr. 2, 2007.
(60) Provisional application No. 61/601,016, filed on Feb. 20, 2012.

(51) Int. Cl. G06Q 20/38

(52) U.S. Cl. CPC G06Q 20/38
USPC 705/39

(57) ABSTRACT

A computer system and software enabling a method for assisting users who are members of a group in identifying trending items and making purchases using selected forms of payment over the Internet on web sites, mobile devices and in physical store locations from trusted vendors to locate and to take advantage of special rates and promotions that may be offered to certain users under specific circumstances. The system enables users, buyers and their social circle of friends of gift givers to identify, curate, manage and purchase gifts & services and take advantage of digital gift cards, credit cards & coupons to get the best price.

### RELATED APPLICATION

This application is a continuation-in-part application of U.S. patent application Ser. No. 12/086,723 filed on Jun. 18, 2008, U.S. patent application Ser. No. 10/594,264 filed on Dec. 6, 2007 and claims priority from U.S. Provisional application 61/601,016 filed on Feb. 20, 2012, the disclosures of the aforementioned applications are herein incorporated by reference in their entirety.

### BACKGROUND OF THE INVENTION

1. Field of the Invention

The present invention generally relates to the field of buying and giving gifts and, more particularly, to a computer system and software enabling a method for assisting users who are members of a group in identifying trending items and making purchases using selected forms of payment over the Internet.

2. Description of the Related Art

Web search and portal companies, such as AOL®, Google®, Yahoo® and Microsoft® Bing, represent the top search, aggregation and syndication market share leaders within the Internet. Generally, these companies provide a particular buyer with a method for performing searches, where the buyer accesses a web site after conducting a search and receives offers from vendors/sellers in a more or less indiscriminate manner. Here, there is no specific targeting of buyers, but rather products and ads are provided indiscriminately to anyone accessing specific sites or clicking on the provided ads, and the web page or ads contain information that relates only to what the vendor/seller intends to sell or offer to the intended recipient of the ad based on the search terms presented.

Buyers are not provided with system intelligence or social assistance in obtaining the goods and services they desire and there is no way for the buyer to negotiate group discounts or find special pricing or real time offerings issued by companies, vendors or financial service providers. That is, the buyers are unable to present their requests to companies or to their various vendors directly or by means of data mining techniques. Moreover, there is no dynamic matching of supply and demand between buyers and company vendors/sellers, no individualized and specific interactions between buyers and their social groups and buyers and various sellers of a specific company, and no efficient way to discover real time prices for specific goods or services. Currently, the ability of companies and their re-sellers/vendors to analyze real time market fluctuations and meet the demands of forecasts and market trends is poor, or marginal at best. Most web sites, mobile apps and web services/API focus on enabling commerce between buyers and sellers. There is no platform that enables, supports and manages social interaction with shopping and payment services between gift givers (herein referred to as the “Lifters”) and gift receivers or recipients (herein referred to as the “Giftees”).

### SUMMARY OF THE INVENTION

An aspect of the invention is directed to a computer system and software enabling a method for assisting users who are members of a group in identifying trending items and making purchases using selected forms of payment over the Internet on web sites, mobile devices and in physical store locations from trusted vendors to locate and to take advantage of special rates and promotions that may be offered to certain users under specific circumstances. The system enables users, buyers and their social circle of friends of gift givers to identify, curate, manage and purchase gifts & services and take advantage of digital gift cards, credit cards & coupons to get the best price.

Another aspect of the invention is directed to a computer based system and method for enabling and facilitating the offer of a multitude of products and services to users who are part of a group engaged in making purchases over the Internet or in physical stores for themselves or for others The system also locates and selects items or services and manages the selection of vendors to purchase from, and includes notifications, preferred payment method and delivery options of each transaction posted or suggested by the platform or by friends and family when they purchase a gift or a service.

The invention also enables such users who are members of a group managed by the computer system to take advantage of special delivery, rates and promotions that may be only offered by the computer system from specific vendors, to specific users or under predefined circumstances for a product or service at a location and time during a specified period. Such promotions may be applicable to goods & services available on web sites, or via dedicated mobile applications or in physical store locations, which are listed or promoted by other group users and whose prices were adjusted or made available at specific locations, via mobile applications or web sites. In addition pricing changes for such promoted products via a combination with Financial Products (FP) such as special promotions provided by specific branded credit cards, debit cards, gift cards, coupons or bank accounts, Electronic wallet (E-Wallet) offerings which enable a financial discount of a specific company, retailer, website, product, location, time and/or place in any combination. Such offerings may be a combination of offers made by company brand owners, retailers, web sellers, individuals and specific financial institutions with new or existing financial products that such users already have may be offered separately from the buyer desired products or in combination through the proposed mobile device application, a web site and the computer implemented system.

In another embodiment the system enables third party merchants who want to sell items or services to the computer system user group or to their own user groups to accept any vendor or company physical or electronic gift card or coupon from any enrolled merchant as a form of payment on their web site, portal, application software on a mobile device or in a physical store. For example the GAP™ stores may offer a 30% off on a web flash sale site or in a specific store location which the system may combine with its ability to buy gift cards offered online at 20% discounted. The GAP gift cards offered for sale by other user on Ebay™ or other marketplace by an individual or reseller to thereby offer a system user a combined 50% off any item in that store. The system arranges for the purchase of the discounted GAP gift card from a third party and enable the buyer to use it online or present a usable gift card carrying the full amount at the store location. In this manner, the system user will get a 40% discount off the regular price, the store or web site sold items at the regular 30% off and the system made a 10% fee on the transaction by enabling such transaction to take place and be processed between all parties. In another example the system may offer visitors who are members of the system via a portal or mobile app any item on the Amazon.com web site at a 15% discount through a combination of a 5% affiliate network commission paid to it by Amazon and discounted Amazon gift cards bought for 20% off from third party users on the web. By redirecting or managing the user traffic to the Amazon.com site and instructing the users to use the gift card payment option at checkout the platform manages the acquisition of various gift cards or coupons from third parties at a discount to face value, the transfer of such stored value to an account managed by the system and dynamically issues new gift cards carrying the face value of the item purchased on the Amazon.com site. The user who is a Gifter or buyer receives 0-25% less than the face value of the debit card provided and the system will still maintain a 0-25% profit from the redirect and 5% from the discount on the gift card.

In another embodiment the mobile application or web site enables a user to list which branded credit cards, gift cards or other bank brands or credit relationships they have so all promotions offered by such vendors can be accessed and aggregated from the central computer system and used as optional form of payment in future purchases based on time, date, location, type of merchandize or vendor name selected. As an example a user may launch an app on his cell phone or computer and browse the app for items listed by other group users, such items can be a topic based listing of top trending items selected by the group official trend setters or other system users the user follows or crowd sourced items which were the top trending items selected by all other users or any combination of these methods. Each item is listed as an image or video, under the image or video the program displays several specific vendors which indicated that they have inventory of such item or service, users can scroll left or right to view other vendors which may offer other options or price. These vendors may indicate the geography they cover, price, size, location of goods in physical stores and delivery method they support. The mobile application knows the preferences of each user (as set in preferences when downloading the app) and their location as well as the variety of payment methods they have entered into the app and uses such selections to display different vendors for each user on each viewed item based on the user location, promotions offered by vendors or financial payment methods the user holds and delivery preferences. A user can select any of such vendors to transact with and proceed to add such item to their wish list, suggest it for other users or purchase such item from within the application by providing form of payment. If such item is being purchased the system may display the preferred payment method offering the most value for this transaction which takes into account all benefits and elements relevant to such user. As an example the app will display the benefits of paying with AMEX Credit card vs Citicard Visa or Discover card the user holds in the number of points, discounts, cash back, miles or other benefits such vendors shared with the computer system. After the user selects the item or service and the payment method the application displays other items other users found to be complimentary or necessary or samplers of items or services that are relevant to such order. User can proceed to select any of such items and select packing, delivery method and specific delivery date for such item. The trusted vendors displayed by the system can be selected and ranked based on an algorithm containing several elements which may include equal weight for the price they charge, the quantity of any trending items they have in their inventory, their historical performance fulfilling past orders, store locations, delivery geography, return policy and other elements important to system users.

In accordance with the invention and as described in my co-pending application Ser. No. 12/086,723 which is incorporated in its entirety by reference, the system provides a centralized, computer and database Platform with a messaging bus infrastructure which supports external API and web site for manual entry (by, e.g, Gifter, Giftee, or vendor) for any Internet user or internet system or service to be notified of trending items and enable third parties to list their inventory, price and delivery or obtain any desired product from other listed items, update or add service and financial offerings and incentives offered by participating company brands and financial institutions and discounts within a short period of time by aggregating web demand from buyers and processing their orders in combination with financial, company branded and/or retailer products and services. System users who are Giftee or Gifters are thus connected to web portals, mobile apps and store supply & demand from many companies, products and financial services vendors. A visitor to a physical store who is a member of the service and who may have downloaded a special app or using a web portal with an optional HTML5 application may view a physical item and then use, for example, a mobile application to scan its bar code or other form of ID or to take a picture of the item or a phone screen picture of an item on a web site or in another app which can be linked to the web address or location of the item selected, and then have a cloud-based web service (i.e. a service provider that uses a cloud-computer infrastructure) identify the brand, model or item via image recognition or with the help of a human agent connected to such platform and search and associate the item with the same or similar items in storage, e.g. memory or trending list inventory and offer the buyer a variety of purchase and delivery options which may include a same day or ground delivery and special pricing if combined with other items or services.

The inventive system or platform preferably comprises a set of servers with a database and a messaging bus which can be hosted locally and/or in a cloud computer infrastructure which serves multiple sources of requests between computers via APIs. These sources include web sites serving clients, mobile devices with apps using the API interfaces, vendors and suppliers who access the inventive system via a web site or API and update inventory, covered territories, delivery options and price information, and financial institutions which provide or update offers, services and authorization of transactions and credit issuance to the users of the inventive platform who hold such cards or accounts or would like to acquire such cards or accounts.

A visitor may follow the following steps: (1) By accessing the platform through a web site or downloading or instantiating (or activating) a mobile application or through one of the participating affiliates and vendors, they can identify themselves by logging in to the system or via an existing cookie, or connecting to an existing social network or enter their personal information or financial account information to identify themselves as registered system users (2) They indicate if they are shopping for themselves or for others and if the item is a gift and should be shipped to them or to the Giftee address. (3) If shopping for others, they may identify these people or companies in their respective social graphs (i.e., in the Internet context it is a sociogram or graph that depicts personal relations of internet users) or via their email, cell phone number or by linking to other applications or links or join groups of buyers in their social graph or on networks such as Facebook, LinkedIn or Twitter and indicate to the computer system the amount they plan to spend on any gift. (4) The platform then sends the Giftee an invitation to join the platform as a user or a notification if they are an existing user and may indicate the identity of the original Gifter visitor, the way they are connected, and/or the amount the Gifter is willing to spend on this gift. (5) The invited party then identifies themselves as a Gifter or Giftee via interaction with the platform through a web portal or same mobile application or other interconnected software application using an API, web site or mobile app. Users can then select from existing trending items or create or add to their online profiles their own items or images & videos of their wish list or wish lists and web tags prepared by them or others via other web sites or applications such as Pinterest™ or Instagram™ and may add curated list of products, images, web links, product tag barcode IDs, applications, services and store and publish it on the platform or cloud computing service with specific groups or individual users with dates and/or prices as reminders or triggers for themselves or others. The computer system may identify any added items and correlates with existing images or videos of such items so a standardized view comprised of all users' uploaded information can be stored and indexed for all users. (6) the platform monitors all listed items and notifies users, vendors and stores which indicated they own trending items when it starts trending and until it is added or removed from any trending list so the desired product can be listed and become available at the desired, date, event, action, communication, social connection or price trigger or the availability of financial products that may be offered and/or found to be combined so a discount on the product searched for can be purchased at the desired target price. This service allows vendors to compare prices for trending items and decide if they want to sell them in their web or physical stores or reserve them for sale via the platform because the trending items on the platform may fetch higher sale prices than same items sold in their own web or retail stores. (7) The corresponding users who are Gifters or a group of Gifters who joined together are then notified of the Giftee's selections, such notifications may be triggered by the Giftee, the platform or third party events such as the item ranking is changed or such item being added or moved from one list to another and include images, video, web links, product specifications, prices, codes or IDs and invite Gifters to select and pay for one or multiple items they approve to be purchased. Alternatively Gifters may have already pre-paid the gift amount selected and approved when they registered with and activated by the system. (8) The disclosed system then proceeds to initiate links, rankings and find multiple vendors for the selected items via postings of other members, its own API, vendor web site product listings and external search services, internet search & location database or via API access and lookup participating third party databases and import, index and create the best combination of product, service and financial offers to match every specific Gifter or Giftee requests and display the top options to the Gifter or automatically place an order and arrange delivery to the Gifter or Giftee based on the requested setting for the item or service. (9) The computer platform receives confirmation of each order, shipment & delivery placed from the selected vendors and proceeds to notify the Gifter, Giftee, friends and family and others connected to their social platform of the status of each ordered item. Other users can also view the curated items and companies, vendors, the web or online sellers as well as physical stores which can handle such transactions. (10) The platform asks first time visitors to identify their respective social profiles which include their social connections, links and social graph as well as ratings and interactions from Linkedin™, Twitter™ & Facebook™ and other social sites or web database and gives them a social score based on their links, Klout™ and number of followers, the verified identity is then used by the platform to issue web and system recommendations based on user profiles to other Giftees and Gifters for whom such gifts or individuals are of interest or are searched for. The platform then enables both Gifters and Giftees to upload and publish, mark or identify any image, service or product on the internet as “wish” “own” or “gifted”. Such wish list can be linked to a company or profile and provide items which were pre-approved for such users or institute a process by which the company, vendor, merchants or re-seller is motivated to offer certain rewards to specific individuals or celebrities who fulfill certain criteria or obligations. In addition, the system monitors and records the actions of the buyers who follow such individuals and tracks and pays commissions for any items purchased after such recommendations, such transaction data is combined with historical data from multiple sources such as their computers or mobile devices, collects previous transaction information and company and brand affiliation from the existing users and vary the search results, recommendations and what is displayed as special offers from selected vendors based on such information. For example a web user with more than 1000 friends on Facebook and high social score on Klout or Twitter may be offered a special price discount by a company owner in exchange for them trying the product and talking about it to their social followers or placing it as a trending item if they are a trend setter on the platform. They may also be offered a commission if their followers proceed to purchase any such items.

The system or platform comprises a portal that is accessed via mobile app, the web or Internet. In an alternative embodiment, the system comprises a plug-in software module, i.e., a system match module that performs search and API queries based on the wish list or actions of users or their social graph friends to whom access was provided earlier via links to social networks. This module which forms part of another program, such as a browser or application specific software. Visitors can select if they are buying gifts for themselves or others and identify the amount they are willing to pay or participate in the purchase of such gifts. Upon certain user-initiated action on a mobile device, such as the initiation of a telephone call, a web search, voice command, visit to a certain location as registered by their GPS or registering with a certain mobile or WiFi network the mobile app software module may initiate a search or retrieve offers from the cloud based platform and its third parties, sellers or merchants and display such information to the user or send a message from the cloud computing infrastructure to one of the user's devices.

The contemplated Gifter system provides a method for companies to interact with millions of users directly and manage where their products are placed and shipped or sold from. After registering a Gifter and the Giftee via a mobile app or a web site operated by the system by, for example, a single click, and verifying their identity the computer servers upload their social graph and history of company interactions which can be accessed via their Facebook “Likes,” email transactions receipts, credit card receipts and statements as well as any other source authorized by the user and items they “Like” or used before into a database of locations, images, links, people, products, brands and financial spending profile. Each visitor then is assigned a ranked brands profile for multiple categories that describes the lifestyle and habits of each user for travel, clothing, accessories, food, home etc. This enables the platform to monitor and publish a curated “buyer's company wish list” that is a combination of items provided by the users and retrieved from third parties the user follows and their company lists assembled via access to their mobile applications, databases and data the user has and to which access is provided. Other sources for company and brand affiliations is available from such sources as transactions on credit cards, phone calls, web and physical visits, user profiles in a database for each individual buyer registered at the web site or on the mobile app. Here, the wish lists are cross referenced with company names and brands and comprise items, web links, photos that include all areas of interest for each individual Gifter and Giftee. Upon completion of the registration with the system, a Gifter and/or Giftee is provided with multiple options based on their shopping history, social score from Klout™ and interaction with the system and associated database. Selected items may be purchased at identified stores, delivered the same day, delivered at a later date, or sent for one time use at various prices. Each shopper can select such options at any location since the platform and not the store or company control the combination and execution of all such options. In each case the platform links the company, the web seller or store location, the financial offer, the delivery option and the service/return policy into a single integrated transaction and a contract with the buyer which may be independent from the financial arrangement with the company, seller, transport provider or return merchandise management infrastructure. This type of aggregation enable dynamic and fluid distribution and normalization of products and services offered to buyers across the internet and at physical locations.

The Gifter identifies the Giftee and elects to notify her or not of his intent to give a gift and the amount he is thinking of. The Giftee can control what the Giftee will know and can see from his selections and for what purposes the gift can be used. The Giftee receives a notification to his email, mobile device or other social network or web site and can use such notification to log into the platform or app and complete their profile. In a first option, the Giftee may fill out a form or select images indicating companies and brands and preferred items or areas of interest, which will be stored into their respective wish list. In a second option, the Gifter or Giftee may transfer pertinent information and interactions, such as likes, shopping, messaging and browsing history, from his own applications or from their social friends into the system history and match module, which will be stored into the buyer's wish list. Finally, the Giftee may proceed with a search for a particular item, brand or within a particular service area, which is then automatically stored by the system into that buyer's company and brand wish list. Such search is conducted in real time via API links and iFrame presentation which allows the platform to view and control the order of the results. The selection can be an action of the Giftee or Gifter through their browser or mobile app or interpretation of the program of the mobile application, or web page the user is navigating to trigger another program to access or scrape the content and images from such page or area highlighted or navigated on such page into the users profile. This program controls the size of displayed items or images, the company selection and form of presentation of the retrieved information and the type of interaction the Giftee or Gifter has with any third party web site or application. This way the Gifter or Giftee results are more closely correlated to their life style, interest and their social interactions. Users may add items to their list from any web site or application and share such information with all or part of their social graph. As such information is collected friends and visitors can easily find what companies, brands, items or services one is looking for and find, select, order and arrange delivery of them directly from such listing and interact with the Giftee or join with other Gifters in the process.

In addition to the foregoing options, the Gifters or buyers may provide their consent to have their information shared with others not on their social graph or loaded or stored in a common wish list database accessible to everyone who may follow a company, brand, an individual, a group or a topic. In the contemplated embodiments, the wish lists contain desired items or services description, brand or product information, images or information that relates to acquiring an item at some point in the future at a certain date, location, price or event. Consequently, each time that the buyer performs a search regarding a particular item on any connected site or application the information is stored into the Gifter's or buyer's wish list or the common wish list database.

The hosted computer processors and central database and servers software module also includes “API & web services data links” to a variety of vendors and companies and specific web sellers or financial vendors offering different rewards and discounts which would match Gifters' or buyers' brands, products or specific requests, links to third party providers, a repository of discounted credit cards, gift cards, coupons and other financial offer and rewards available from certain companies or vendors. Here, the vendor offer may be integrated into the seller site or provided in a separate offering with special instruction on how to use them with the selected vendor. These offers may comprise date, price and quantity limitations, combined packages of different items or quotes for lump sum promotions, which would be offered together only if a predetermined dollar value, financial product and/or a specific product would be sold to each specific buyer. Alternatively the platform may initiate an offer to a user by checking his credit score or available unused credit and recommending a new credit card, bank account, financial service with instant approval for which the platform may be compensated by the issuer and thus can offer a portion of such reward in a form of a discount for one of the most desired items on a user wish list. The user can then shop on any site and use a gift card, coupon or prepaid CC as form of payment.

Another embodiment of the contemplated system continuously accepts and extracts all product and financial offerings from all third parties connected to a computing device and attempts to put together the best offer which combines company promotions, product discounts and/or financial offers. The central database correlates such offers to companies, brands and web & store vendors so users can be dynamically informed on the vendor web site, by email, mobile app, search engine or when they visit a store, the web site, or see advertisement. Such special offers may be “10% off all GAP products in the next 2 hours”, “Buy GAP today with a Gift Card from any other vendor and get 10% off”, “Buy at least $200 in GAP products anywhere and get a $20 gift card for any company you like”, Such offers may not be available from the companies or web vendors directly but because the platform enables combination of products, services and financial offers it may combine offers for items that otherwise are not available anywhere else. Such offers may be extended for shopping in stores and physical locations in addition to web and apps as users are provided with E-coupons and E-gift cards that are dynamically generated to enable special pricing and fulfill each request or each order. The user is prompted with the actions and steps needed to be taken to take advantage of the offer. In some instances all such steps may be integrated in the platform or company site and in others the user may need to take several actions which then will enable them to take advantage of the offer with a web retailer or a store location. In accordance with the contemplated embodiments, the system may aggregate a group of buyers, who are interested in obtaining the same item while benefiting from a discount or reward, and matches the number of buyers to the number of items associated with a lump sum promotion that the vendor is willing to provide.

The contemplated system of the invention enables users who are Gifters and buyers to use any vendor gift card and coupon for any other vendor or merchant in any mobile application, web portal store or store location. The platform utilizes a central repository which is connected in real time data links from the gift card issuers and their financial institutions such as GAP, American express & First Data Corp to verify the validity and amount of credit on each card or coupon. The specific credit and debit cards, electronic gift cards, store credits, physical gift cards, coupons and other financial products may be issued by a company or a vendor or available for re-sale from third parties and are valid and in good standing for immediate purchases. The system enables purchases to be made on the system portal or enable other merchants to accept such payment from others on their own portals mobile apps or physical store front. For example, in the event that any system user has selected items on the platform and is ready for a purchase of $200 in merchandize from the vendor GAP, the system may tap into existing inventory or electronically notify any sellers or vendors of GAP financial products connected to the system such as plastic jungle, eBay, First Data, users who own Gap gift cards who indicated their intention to sell and complete a transaction of one or multiple gift cards at a 20% discount or $160 to the face value of such GAP issued physical or Electronic gift cards, and the gift cards is then “marked VOID” in the vendor or First Data database such that no one can use it and the full balance of $200 on such cards is then transferred to the platform account with First Data or the gift card Vendor. Next the system may instruct First Data via API to issue to it or the buyer a new GAP gift card from its account for an exact amount corresponding to the Gifter client checkout cart balance. The buyer indicates to the platform that he needs $200 of merchandise and the platform will then deliver such newly issued electronic gift card as a bar code in a mobile app, a deposit in a “mobile wallet” (i.e., an electronic or online financial account), deposit into an online account such as PayPal™ or number or image via email, mobile app or as a number or code on a web site depending on where, when and what the system user needs at that time of purchase. The user can then use such code to complete the purchase at the vendor web site or store without any further interaction or change in the way GAP does its business. This transaction generated $40 in profit to the platform of which some may be shared and provided to the Gifter or Giftee or referring individual they follow.

Alternatively, if physical cards or non API connected vendors are used the rebate or credit provided to the buyer is maintained in escrow for an extended period of time prior to being released to the buyer. The system may use a credit card or other payment guarantee to extend such credit to the user.

The system and method of the disclosed embodiments provides a centralized system that acts on behalf of multiple merchants and provides a controlled and manageable way to monitor and issue new forms of payments and rewards, discounts, coupons and commission payments to customers. Moreover, the system performs calculations to allocate discounts and rewards for individual buyers, designate final prices for individual buyers, and provide fast and efficient settlements of outstanding balances between sellers and buyers of such secondary market financial products.

This invention is also creating an automated market place which enables the exchange of financial values and rights to services or products between sellers of such gift cards and unused coupons and buyers who would like to take advantage of such discounts but don't want to deal with the physical purchase and manual application of such coupons or discounts with their web purchases or in store purchases.

This invention enables end users who are trying to buy items from known brands to visit the Gifter web site or use a mobile app to directly access such discounts. The Gifter site has a listing of major brands and the special discount that is applicable that day for each such brand by any seller of products and services of such brand.

In another embodiment the system enables every merchant who has a portal, application specific software or mobile apps or physical store locations to accept as a form of payment (FOP) gift cards and coupons from any other merchant who is approved by or is a member of and part of such system. For each merchant a discount level may be established under which the system will accept additional redemptions of cards or coupons. All merchants including the portal operated by the system can then accept payments or partial credits for any item using cards or coupons from any other approved merchant. The central system uses data links and API links to all available issuers and owners of such cards and coupons to validate, transfer and re issue balances between itself and its members and approved merchants. In physical store and exchange locations checkout clerks or dedicated people may be used to accept physical or virtual cards and coupons, validate them with the inventive system by scanning the card, taking picture of the image of the card, swiping the magnetic card, entering numbers posted on the card and then affect a transaction which transfers such balances to an account managed by the system and then credits the merchant accepting such payment to issue their own store or discount credit based on the amount the system and such merchant preprogrammed as a discount. The discount may be split or retained by the system and the merchant.

In another embodiment the system effects transfers of such credits directly between the selling member via its issuing institution and the party who is accepting the payment and their account or processing financial institution.

For example a seller of a GAP card can interact directly with a buyer of a GAP card and execute a transaction even if the selling amount is different from the buying amount on the cards. The platform uses its software to manage the transaction and charge any applicable fees. Any owner of a gift card or store credit can enter such info on the app and then be displayed offers by the system which he can accept at any time and affect the transaction. In another example the platform operator may partner with companies such as AMEX™, Discover™ or Ebay™ (web merchants) to use debit card & coupon transactions with Amex, Discover or Ebay authorized merchants and offset such transactions at the end of each settlement day against any Credit Card or other sale transactions conducted on such external systems. Such settlement where a sale by any seller using AMEX credit card account results in an amount owed by AMEX to said seller can be offset by AMEX with any transaction where said seller has accepted a third party gift card from a buyer and was issued a gift card or credit by said seller, this allows for all such vendors to accept any gift card from any vendor as long as it is backed and cleared by the web merchants. If AMEX has processed $1 million worth of sales for a specific store or web site it will deduct the total amount of credits and discounts it has issued for users who paid with gift cards from other vendors. This offset, done by the clearing web merchants, enables orderly and quick settlement and net off of all balances related to the present invention. Enabling and combining such netoff in the transaction can provide for a variety of combinations and offers by all related parties as described in this invention. It also enables issuers of credits and gift cards to reverse liabilities associated with their issued gift cards and book them as sales on demand when they need them against an inventory of willing sellers managed by the system.

The buyer can visit any site or use any app on the Internet by using a mobile app or a browser enabled with the iFrame provided by the system on any site and take photo of such item with the device camera or app or select any item they would like to purchase on their browser and snapping or capturing the picture and attaching the web site link via an application provided by the system and then have the system source the appropriate gift card or discount coupon.

The Gifter platform looks up its internal database for balances on such merchant or that of its financial partners to see if it has in inventory the monies needed to generate a gift card or coupon to cover the sale to the buyer. If it does not the platform uses existing data links or intermediate clearing agents such as First Data or Amex to contacts the selected company API or financial institution to direct a transaction to generate such card or increase the platform credit. As an example a visitor to the discount site or mobile app selects “today 20% off all Amazon products” which directs him via an iFrame browser window to a page on the discount URL web site or initiates a mobile app that has the same listing or availability. The user then browses through the Amazon.com listed products and selects a video camera Amazon has discounted to $100.

The user presses the “select item” button which can be located on the discount site or outside the iFrame on the gifter site which takes him to the shopping cart or triggers an API query from the platform back end to the Amazon API to generate the shopping cart for the selected item.

Amazon returns with the item ID and all relevant information which the discount site uses to construct a “checkout” page which includes the items selected the published Amazon price and the promised discount of 20% issued by the platform. Alternatively if the shopping cart was generated by the Vendor inside the iFrame the platform issues the user a new gift card in the full amount of the purchase price but charges him only 80% of the value to affect the 20% discount.

The user then provides a form of payment and shipping information or provides his amazon credentials so the data can be accessed, verified and extracted from the Amazon API interface with the system. After the order is placed and the user Credit Card authorized for $80 plus shipping costs the Discount web site sends an order to Amazon using its own master account and its own form of payment. The order includes the item and any other discounts or offers that can be combined to get the lowest purchase price from Amazon. For example the discount web site has purchased coupons from other Amazon clients which may be applied for this purchase or a gift card or a special promotion or shipping discount all at a discount from the face value. Such purchases take place separately from any transactions being processed with buyers. The discount web site publishes the discount prices it will pay for any standard gift cards or existing coupons and invites visitors to transact with the site. For example an Amazon gift card with a $100 face value may be bought by the Discount web site for $70 at any time. It then can be used by the discount web site to pay for any purchase it makes for any item selected by a visitor looking to buy a video camera on Amazon.

In this example the discount web site will spend $70 to buy the gift card and a few days later or a few minutes later may use this card in whole or in part to pay for one or multiple items it is purchasing for one or multiple buyers.

In total the discount web site cost is $70 and it “sold” the item to a web customer who visited the Discount web site for $80 even though all other visitors to the Amazon.com web site will pay $100 for such item. This process allows a win-win-win relationship among the buyer of the video camera, the discount web site and the seller of the gift card who gets to monetize his card quickly without any need to transact or interact with the party buying the item.

The amount of discount on the brand name or on the gift cards may vary based on the company and brand, time of day, day of month, type of card, the State or jurisdiction in which it was issued as well as the state in which the owner lived or purchased the card and other conditions which may limit or change the value, expiration date terms and conditions or use of such item. The discount level may change based on the demand for such brand on the discount web site or the cost to acquire new customers for such company or brand. It may vary based on the conversion ratios of such visitors, which trend setter or referring party initiated the transaction, the average purchase price or margin such visitors generate. Since each item has different margin and pays different federal commissions which can be combined with gift cards as form of payment a very complex algorithm can be used to optimize this process to generate the best return on investment. For example the platform can add up following discounts from face value: 2% for card being issued in NJ, 1% for being a referral by system user, 5% for being issued by 800Flowers, 2.5% for expiring in less than 90 days, 1.1% for transaction fee with First Data, $10 for NJ tax. Since the discount site has to maintain an inventory of valid cards for each company ahead of any purchases being processed from new visitors a value of capital calculation can be added which selects which cards to buy and promote to generate the best returns and with the fastest turn around. Since some company cards don't have much demand or have seasonal use like flowers or gift sites buying gift cards from such companies may involve having to hold them for an extended period of time which needs to be added to the calculation of what discount should such cards fetch to make them attractive.

The steps described which are taken by different participants using parts of this system may vary but the described modules all enable a variety of transactions between Gifters and Giftees which are enabled by companies and Vendors who sell such products and third parties who enable such products to be sold below or above their regular retail price levels on other sites. The platform enables transparent execution of such aggregation by maintaining a constant inventory of Gift cards, flash sale coupons and other products for the most popular vendors and continually replenishing the inventory of such cards from all sources who offer them for sale just in time and based on the demand levels projected by the platform. By relying on the user's history of purchases, trends relating to sales of individual items, supply and demand of any specific items, amount of sellers or users who indicated they want to sell their cards or obtain cards, the system can determine whether to accept payment from the card.

The platform database is continually updated with new prices, new products, financial offers and items for sale by individuals which are taken into account in the way offers and discounts on company products or services are presented to buyers on the web site, the availability of certain offers from vendors dynamically changes the daily or hourly offers made to visitors of the site or the mobile apps and the offers physical stores can display on their windows and in the stores which are based on the offers the system drives to them.

Buyers are presented with offers twice during the buying process, the first time is during the product/service/brand selection where they can see specific discounts or offers tied to specific discounts and then a second time during the payment option selection where buyers can see further discounts or offers that are based on additional steps they may take. For example, a shopper who selected a video camera in the first step and was provided with a 10% coupon discount may be offered to pay with a new credit card as a new payment option. The system checks the visitors credit score to see if he will qualify for such offer and if so can dynamically prompt him with a special $50 off offer. The user may also be prompted to pay with gift cards, the platform can accept all types of gift cards from all vendors that can be electronically validated. The platform may offer different discounts for different gift cards to achieve certain profitability or margin based on market prices and its internal level of inventory for such cards as well as the level of demand from other shoppers for the specific company being offered. All such elements may be continuously adjusted and changed to improve and maximize the overall margin and conversion ratios on the sale of cards and purchase of merchandize and services via the platform. Access to all such real time data can be provided from a monitoring station and be administered by the system administrator to make changes and decisions. The expiration date of the card and the amount of credit may also influence the price being offered. The user or shopper will be provided a way to enter the company, brand and card value as well as the serial number or image of the card being sold (to ensure validation of the balance on such cards) and be offered a value which may be a discount from the face value of such card as a form of payment or partial credit for the item being purchased or as a general credit to one's account. Each such offer while independent can be applied as full or partial payment for any one or many items being purchased or used as a gift credit to be awarded to other shoppers or friends of the Gifter.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is a schematic block diagram of the system in accordance with an embodiment of the invention; and

FIG. 2 is a schematic block diagram illustrating the system match module of FIG. 1;

FIG. 3 is an exemplary block diagram illustrating the interaction of the components of a system match module associated with providing coupons in accordance with the invention;

FIG. 4A is an exemplary block diagram illustrating the payment options displayed to buyers and sellers.

FIG. 4B is an exemplary block diagram illustrating the interaction of buyers and third party providers pursuant to placing orders for certain items;

FIG. 5 is a flow chart illustrating the steps of the method of the invention associated with processing a transaction.

FIG. 6 diagrammatically illustrate the exchange and steps taken by users and merchants who are enabled by the system to accept all types of cards and payments.

FIG. 7 describes the options users see when they elect to pay with one gift card for another brand.

FIG. 8 shows the validation process of the submitted gift card and the balance the user has on such card.

FIG. 9 shows the net totals approved for purchase and the card balance that may apply for such purchases.

FIG. 10A is an image showing how the inventive system displays the summary of a transaction for users.

FIG. 10B shows the user interaction with the system and the order by which favorite items system wide are selected and displayed to all users.

FIG. 11 is a diagram of the mobile app and the user interface and display of the top trending items.

FIG. 12 is a schematic diagram of the system components and architecture.

FIG. 13 is a diagram of the process by which vendors add and manage product and service inventory and pricing.

FIG. 14 is a diagram of the user process to add credit cards and gift card they own.

FIG. 15 is a process flow diagram showing the flow by which users add items and manage the top trending list.

FIG. 16 illustrates the ordering and selection process for users.

FIG. 17 is a diagram showing how social score and system orders are combined to select trend setters.

### DETAILED DESCRIPTION OF THE PREFERRED EMBODIMENTS

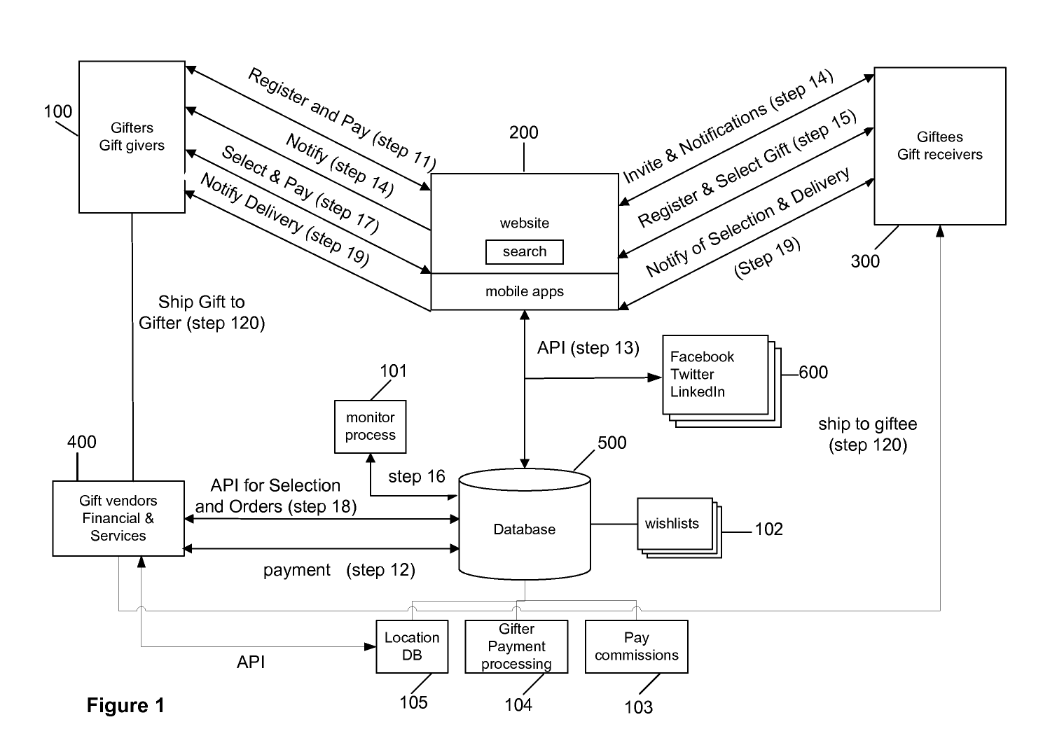

FIG. 1 diagrammatically depicts the interactions among the variety of entities and systems which are part of the inventive system. In step 11 Gift givers or Gifters 100 use their computers or mobile devices to register with (a) a central web site 200 via a browser or mobile app browser (b) a mobile application (e.g., a native app) resident on a mobile device linked to remote servers or (c) a mobile web service or browser enabled API accessible via HTML5 to a hosted set of servers which enable access to data and services (for rendering the data to user) or a combination of these systems and platforms. The mobile apps, web site & its set of servers and data base (DB) 500 are linked via API and internet data links to a variety of data and service providers such as vendors and financial partners 400, Social networks 600, wish lists 102 and other providers. Each interaction with Gifters or Giftees 300 can generate a different sequence of events between the servers, the DB 500 and third party networks such as private lines or special security networks used by financial institutions. The following description is an exemplary sequence intended to illustrate the inventive steps provided by the system.

Gifters 100 login & register with the website or via a mobile application (platform 200 and Database 500) in step 11, their profile is created in database 500 in step 12 and they can then indicate whether the gifts are for themselves or for others and the amount they wish to use for the gifts. A payment form is provided by Gifter and then authorized or processed in step 104. The platform 200 may use the payment processing module 104 to verify a gift or debit card balance, authorize or charge the Gifter Card if necessary and deposit the balance into the Gifter account in DB 500. In step 13 the Gifter's profile and/or identity is authenticated via one or several social networks 600 and his profile and social graph may be imported to DB 500. The Gifter can identify one or multiple gift receivers through his social graph as part of Step 13. In Step 14 the platform initiates communication with the Giftee 300 identified by the Gifter in step 13 via one or multiple messages. If such Giftee already has a profile with the platform such notification can be made to the mobile app or his email or the platform may use a social network such as Facebook, Twitter, LinkedIn or a telephone or web messaging platform such as Skype to invite and notify Giftee of the intent of Gifter 100. In Step 15 the Giftee 300 responds to the invitation and registers with the platform creating his own profile and linking it to social networks 600, he can then proceed to use the web site 200 or download an app to his device 300 and start tagging or selecting items that are of interest or he is looking to buy. In Step 16 the platform monitors all such activity by the Giftee and posts any selections to the Giftee 300 profile keeping links, metadata and other available information about each item selected or imported by the Giftee. This monitoring service identifies and categorizes the items by price, vendor, company, brand and priority. In Step 17 the platform informs the Gifter of the items selected by the Giftee and provides view or link so he may select one or several of such items or approve the items selected for purchase. At this step the Gifter may select to pay for the gift or change form of payments already provided, and may indicate if the gift should be picked up by the Giftee, delivered to the Gifter address or send to the Giftee and setup a delivery date. In Step 18 the platform uses its API and internet links to order such product selection from vendors 400 and process any financial products or services linked to the transaction. After receipt of confirmation of the orders placed and processing of payment with vendors 400 the platform updates the records in database 500 to reflect the final transaction. In Step 19 the platform informs the Gifter and Giftee of the final transaction, the scheduled arrival dates, the items selected and any other related information. In Step 120 the items are shipped to the Gifter or Giftee as per the original instructions.

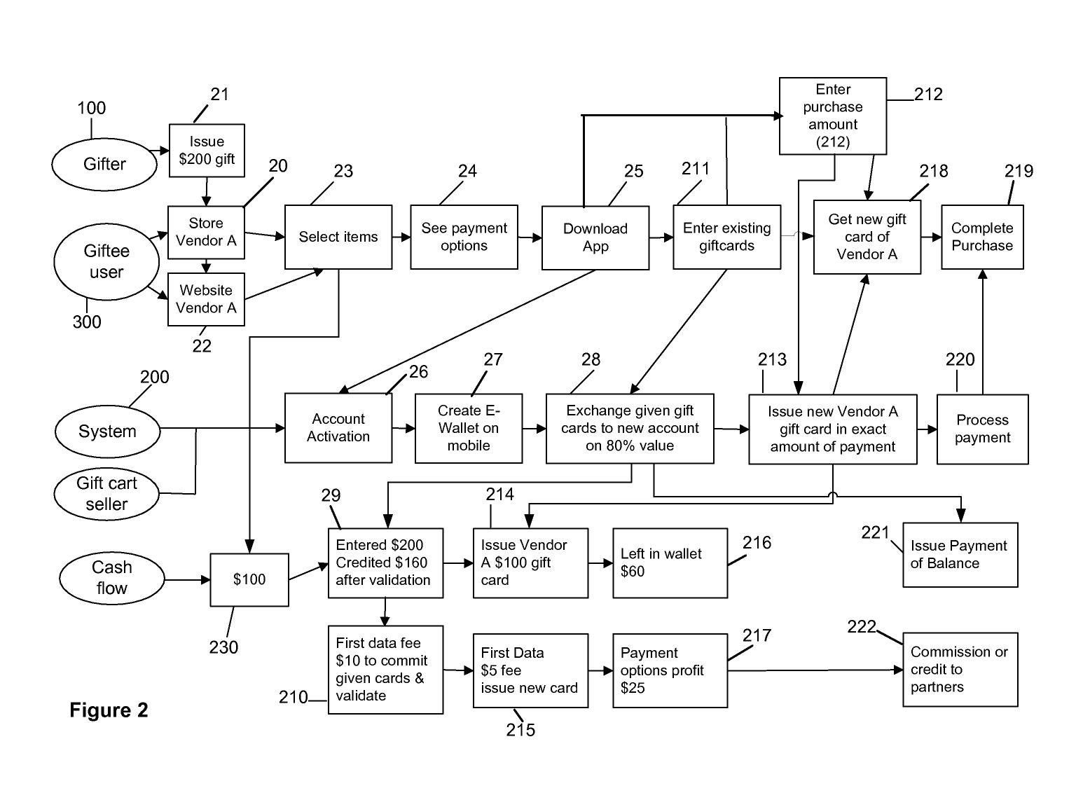

FIG. 2 is a schematic diagram describing the steps and interaction between the Gifter, Giftee the inventive platform, payment methods and the financial flow of the transaction. Gifter issues a $200 gift in step 21 (on web site or after downloading an app) and Giftee selects a $100 item in step 22. Gifter is shown items for selection in step 23 and payment options in step 24 downloads app (if accessed via web site) or activates web account in steps 25 & 26. The platform then accesses an existing electronic account on a mobile device or creates a new account on the platform in step 27. If the Gifter provided forms of payment in step 211 and the item selected in step 23 cannot be purchased with such credits the platform may exchange one form of credit to another to affect the transaction in step 28. The platform uses step 29 and 214 to validate, authorize and exchange a $200 gift card from the GAP to a $160 deposit in the e-wallet. In step 28 the platform instructs its partner First Data to cancel the $200 GAP card by providing the card information obtained in step 211 and instruct First Data to move $200 balance to an existing GAP account the platform has with First Data. The platform then pays $10 for such transaction in step 21. In step 212 the Gifter or Giftee may enter the amount of the purchase and the vendor selected or such data can be obtained by the system from the browsing or API information captured in steps 20, 21, 22. In step 213 the platform proceeds to process a transaction which will directly process the payment with the selected vendor or issue the Gifter or Giftee a new gift card, debit card or credit card with an amount of the exact purchase of item selected in step 23 or the value of the entire wallet created for them based on deposits and other transactions performed in steps 211, 28, 218, 27. The platform can use its credit lines with financial institutions, links and agreements with financial institutions, vendors and companies in steps 214, 28, 213 to issue a new gift card of vendor A in the amount of $100 and provide it to the Gifter or Giftee in step 213 to compete transaction in step 22 and 219. Alternatively such form of payment can be used by the platform to process the transaction directly through step 218. The $60 credit left in the user profile can be stored in the user profile in step 216, added to other account in step 27 or issued as a gift to other Giftees. After processing said transaction in step 22 and paying First Data a fee to issue new gift card for $100 in step 215 the remaining $25 profit can be deposited or transferred by the system to cover other transactions or to pay third party commissions in step 222 for any introductions or fees agreed with partners for completed transactions.

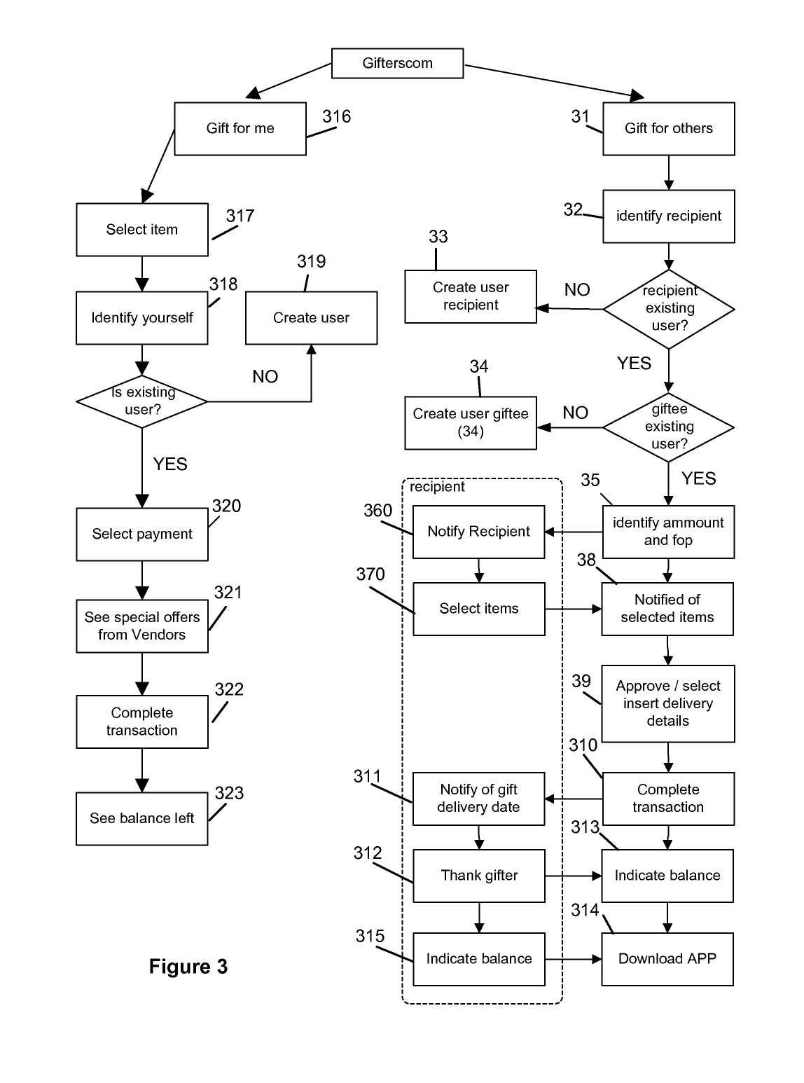

FIG. 3 is a flow diagram that describes one scenario of the inventive system. FIG. 3 shows two characteristic flows depending on the user role—Giftee (recipient user)—(i.e. a user receiving a gift from another or buying a gift for himself) or Gifter—(i.e., a user buying a gift for other or for themselves). Upon selection of the role Gift for others 31 user is asked to identify the recipient of the gift in step 32—recipient (Giftee) can be identified as an existing user of the inventive system, by his/her email address or by his/her username on one of the existing social networks such as Facebook or Twitter. If identified recipient is not registered in the inventive system a new user account is created for recipient in step 34. If Giftee is not registered on the platform a new user account is created for the giftee in Step 319. Upon identifying the recipient of the gift (i.e., Giftee) in step 32 user is asked to identify the amount of the gift he/she wants to send to the Giftee as well as a form of payment. The user can select a credit card, or an existing gift coupon that he owns and enter or by his/hers current balance recorded in inventive system. Payment by balance in the inventive system in step 32 and 35 is for logged in users only. Notification is sent to the recipient in step 36. Means of delivering this notification depends on the recipient identification in step 33—for users already registered in inventive system an email message or in mobile app notification is dispatched, to user's without an email address on record or no downloaded app in the inventive system the Gifter is asked for contact information. For new users a temporary user account is created in the inventive system in step 33 based on identification data supplied in step 32 and notification about a gift with login information is sent to the gift recipient either to user's email or by message via an API connection to social networks. Upon receiving a message about a gift, a gift recipient is asked in step 37 to select one or multiple items to use his gift certificate to. User can select items from his/hers existing wish list or insert new item or items. Upon completion of the list gift recipient submits a list to the inventive system. Upon list submission Gifter is notified of the selection in step 38. Gifter has an option to approve items selected by the gift recipient and to choose delivery options in step 39. In step 31 Gifter can confirm the amount and form of payment. Upon confirmation of transaction—in case of payment by credit card—specified purchase amount is processed and transferred to the vendor's account who sold the item selected or to a trust account managed by the platform through which all settlements with vendors are performed. In case of gift coupon—submitted coupon is invalidated at the central processing database or with a third party account processing provider via an API and funds from the accepted coupon are transferred by the third party processing partner (e.g., First Data, or Amex) to an account managed by the platform. In the case where form of payment being the existing balance recorded in the inventive system Gifter's balance is decreased by the specified amount and that balance is transferred to the Giftee. Upon completion of a transaction the Giftee receives a notification of transaction in step 311. Gifter is presented with the balance of his account in the step 313 and asked to download an app in step 314 if he did not do so already. Upon receiving gift delivery notification in step 311, recipient (Giftee) is asked to send a thank you note to the Gifter in step 312. Recipient can send a thank you note or skip this step and is taken to a page that indicates new balance of his account in step 313. Upon selection of the role “Gift for me” in step 316 a user is asked to indicate desired items for purchase in step 317. After that user is asked to identify himself in step 318 either by his registered username in the inventive system or by his email address or user name in one of the social networks. When user enters his identification information a new user account is created in step 319. Upon user identification user is asked to select form of payment for selected items. User can select following forms of payment: credit card, existing gift card that user can submit to inventive system or user's balance recorded on the inventive system. After selecting form of payment user is presented with trending items and vendor's special offers in step 321. Special offers include various discounts and deals connected in any way to selected items including but not limited to companies, type of product, location etc. User may select one of the special offers to add to his purchase and proceed to step 321 where he completes the transaction and is presented with remaining balance in step 323.

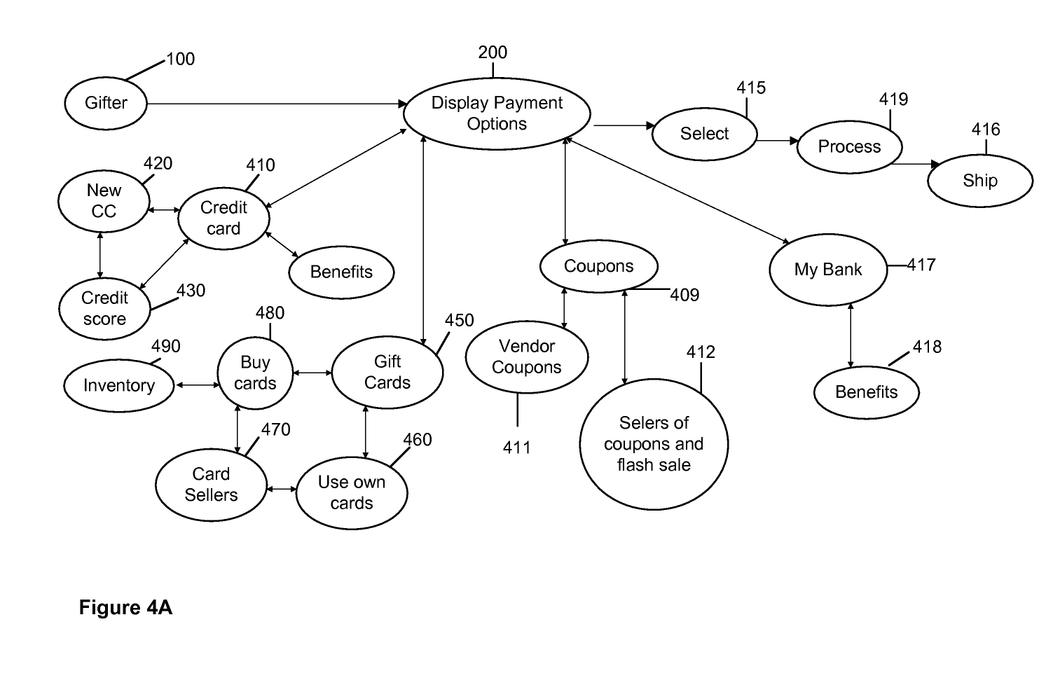

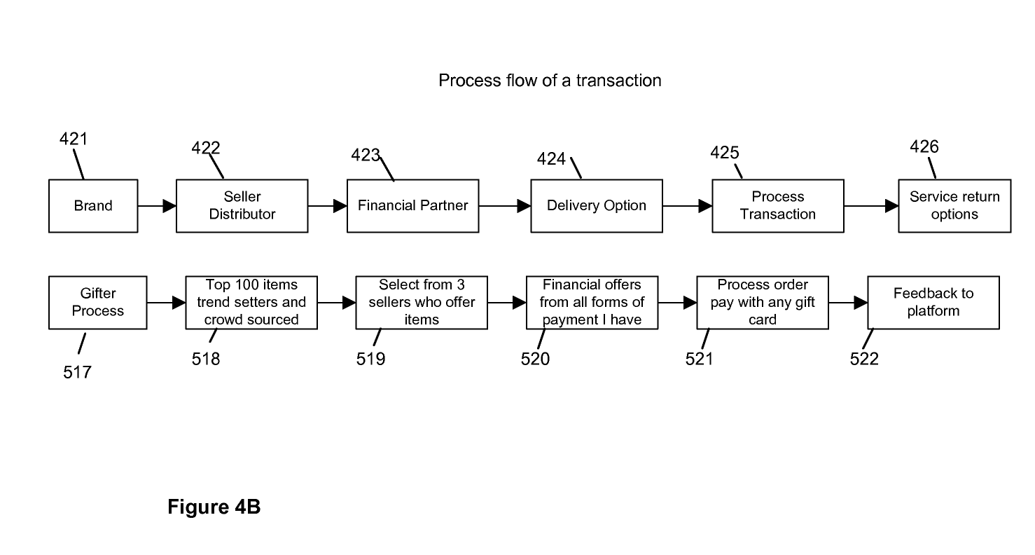

FIG. 4A describes the variety of payment options that may be combined dynamically in different ways to create the best value proposition for each Gifter. The platform uses all financial and product offers from third parties and combines it with its knowledge of the Gifter and their financial information to identify the best package or continuously track such offers to affect a transaction for any of the items selected in the wish list. As an example Gifter or Giftee 100 can use the system web site or mobile app to enter their existing payment options accounts company and specific affiliation such as “Citicard™ American Airlines” which enables the computer platform to identify the benefits associated with that vendor and specific card and estimate the costs and fees of each payment option for each transaction. Since most users don't know all the available benefits associated with their cards and accounts few take advantage of them at the right place and time.

By also entering the card or account numbers including their credit cards 410, gift cards 450, mobile accounts, coupons 409 and relationships with financial institutions 417, a detailed accurate and complete cost and benefit 418 can be presented with each transaction. They can also provide additional information such as social security to enable credit scores and other profile information and access to social links and preferred vendors. All this information is combined with postings and entries made by third party vendors and suppliers about their offers and benefits 418 and how these tie with specific transactions and individuals (via terms and conditions) for every bank account, card or vendor. By pulling all such information together the system can use its algorithm to accurately estimate the benefits and additional costs related to any transaction a user initiates. The information can be also extracted via API with participating financial institutions that agree to parse and order such information so it can be extracted and populated properly in the system database 500.

The computer system is connected to a variety of vendors listed on FIG. 4A and has an internal database that lists all the variations and rules that apply to each vendor and their offering. For example an American Airlines CitiCards Visa may have specific rules for use of points, miles, interest rates and special promotions with specific vendors. By linking such rules with entries made by users of the payment options they have and linking it to specific items and selling vendors for each trending item a ranked listing of payment options can be presented to each user for every transaction that shows both the cost and benefits of each selection. As an example since each card has various interest charges and other fees it may be cheaper for a buyer to use a gift card from a third party and receive 20% discounted value than pay 30% yearly interest on a cc balance. By displaying such options and using the history of user shopping and payment history the application can show all payment options normalized for each purchase. Selection is made by the user at 415 and the system then effects the action necessary to receive the benefits at steps 419 and 416.

FIG. 4B describes the process flow between the various participants in the transaction and their specific terms related to product availability, selection, price, credits, shipping options, return policy and the ability of the platform to effect a transaction via the web or a physical location based on the delivery instructions provided by Gifter or Giftee. Vendors or companies 421 can place products and offers on the platform and offer them for direct sales or link them to preferred sellers or distributors 422. Trending items listed by users and trend setter 518 can be then linked to or associated with companies, brands and distributors who offer them for sale.

As the inventory of items for sale increases and the options for sellers increase a broad variety of transactions is enabled for the users. These users populate their credit cards and financial information which enables the financial partners 423 to be better selected by the platform as well as to provide special offers to shoppers who have specific characteristics such financial partners are looking for. For example monthly spend levels or average purchase price. Users can then select delivery options 424 which may be different for participating distributors and variety of items. After all such options were selected the system can process the transaction at 425 and handle any credits or service returns at 426.

In another description of a process flow the system can be configured to enable users to take advantage of specific benefits in a specific order to maximize the overall platform value and optimize the customization for each user. The process may start with Gifter process described in Step 517, a user then proceeds to browse one or multiple top 100 trending lists assembled by trend setters and crowd sourced by all users 518, upon selection of any item the system displays three preferred vendors who best match the user preferences at 519. Then the platform and the mobile app or web site process all available financial offers at step 520 and display the most beneficial payment method. In Step 521 the user can proceed with a transaction and pay with a gift card issued by any vendor as described above and in the last step 522 may provide feedback on the product, selected seller or financial offer which will affect their rankings and options for other users.

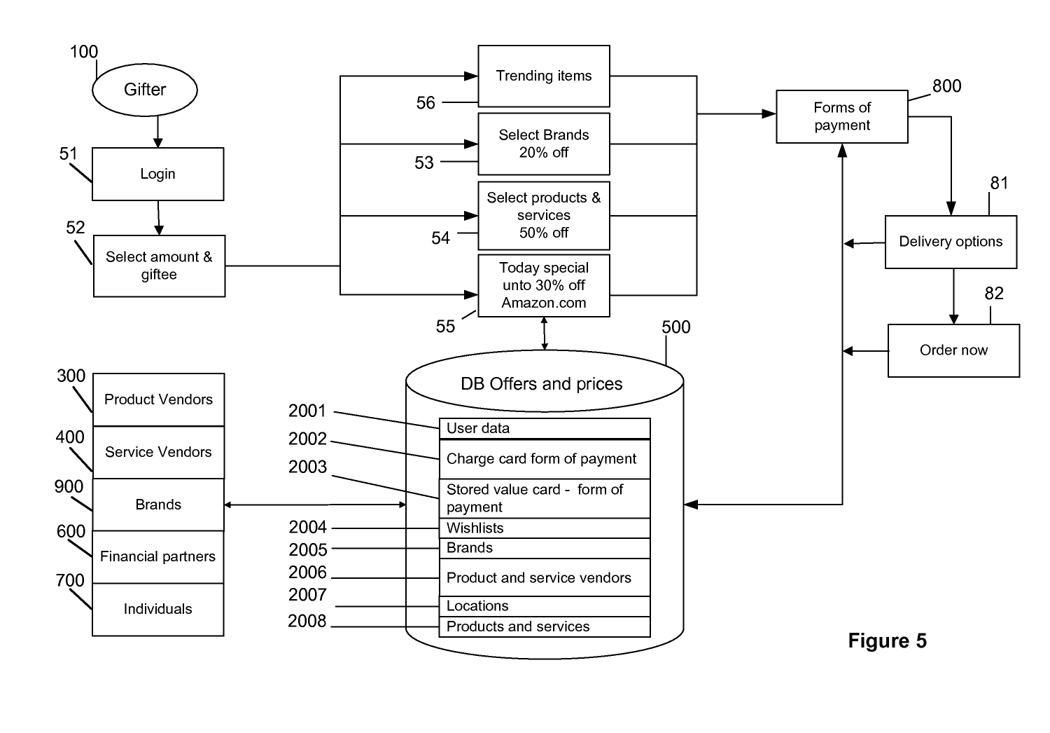

FIG. 5 describes the display options that may be presented to Gifters and Giftees entering the system. The Gifter may restrict the selection shown to Giftee or take advantage of specific offers made that day or hour to offer them as gifts to others. Users who access via mobile apps or via web site can follow lists of trending items 56, select from specific companies or brands 53, special offers 54 or special discounts on specific vendors 55, dynamic update are placed by product vendors 300, service vendors 400, companies/brands 900, financial partners 600 and individuals 700 which are organized in database 500 to be selected and displayed. Finally, the selection of delivery options which may include gift wrapping and special delivery are handled in step 81 and final order processing is handled in step 82.

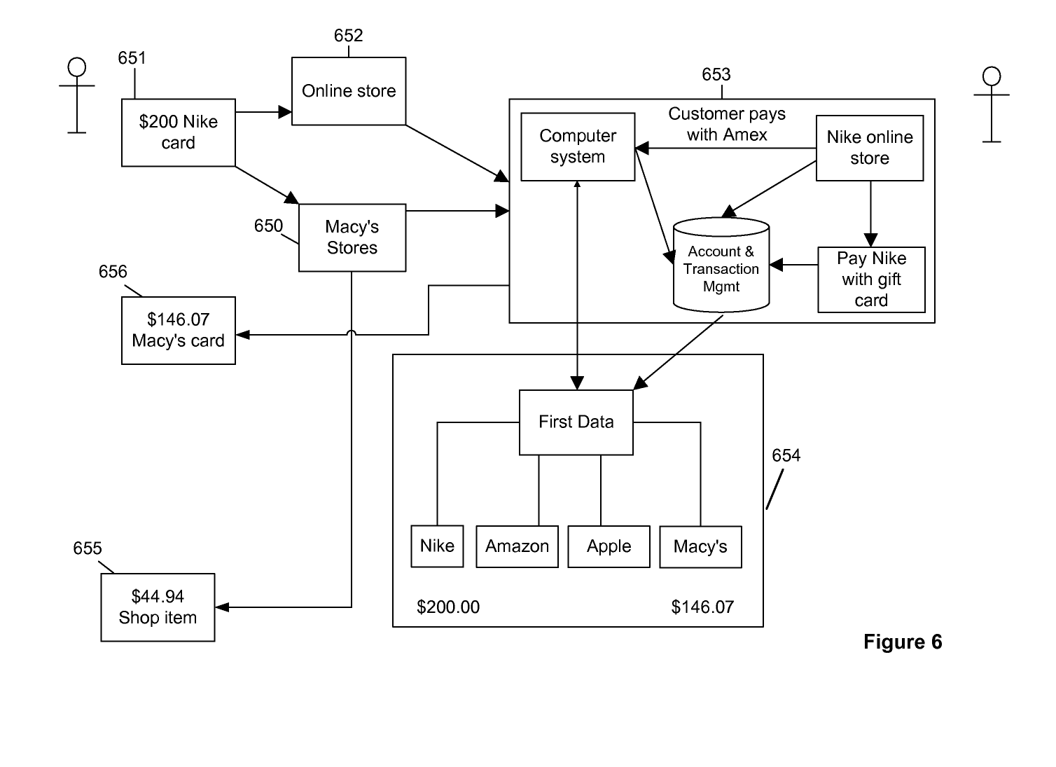

FIG. 6 illustrates how users may visit a merchant such as Macy's™ web site 652, mobile app or store front 650 which is connected to the computer system and use any card or coupon from accepted merchants such as a $200 Nike™ gift card 651 to pay for any merchandise or service they find. The Macy's portal or sales person uses an application or API to validate the Nike card with the computer system 653 which in turn accesses third party issuer of the gift or credit card such as the First Data™ (FD) system at 654 to validate the users $200 gift card, the system then arranges with first data to transfer the balance of the user Nike card into a different account the system has with FD, net off such balance against its Macy's account, redeem such card for cash or to transfer the balance to a new or existing account with its own Account & Transaction Management database (ATM) and then invalidating the original Nike card, in another embodiment the balance may be created with another issuer such as ANEX™. The system then issues Macy's the balance if any in a form of a new Macy's gift card for $146.07 on 655 which is the remaining balance form the purchase of shirt for $44 at 656. The system thus retains $8.99 as transaction fee. Such card can be issued as electronic or physical card by FD, AMEX or the system ATM. Macys then provides such card to the user in electronic or physical form, via mobile device application or on the web site or in a physical store via terminal printout or balance transfer via wireless means to a user device or such card is issued directly by the system to the user. In turn the computer system thus has a credit of $200 with Nike and debit of $146.07 with Macy's, it will issue a payment for $44.94 to Macys as transfer of funds in settlement of this transaction. In a separate transaction the system may offer a sale on Nike items on its own portal 653 or app on a third party site such as Vente-Privee™, accept payments from visitors with Amex or other cards and pay Nike or net off payments with such $200 credit it holds with First Data or in its own accounts. By aggregating many such transactions and settling them daily a net off of all such balances will take place by the system on behalf of all merchants against all transactions and against credit card and other transactions. If the netted card balance is less than the purchase total then the user will be prompted to add another gift card or Credit Card or coupon to affect the transaction.

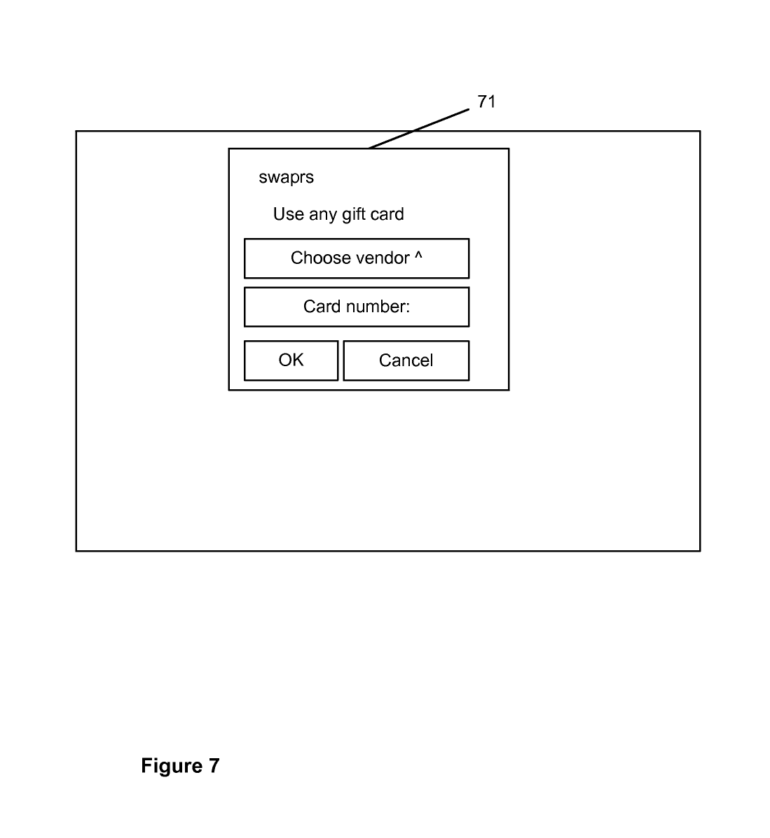

FIG. 7 illustrates what the computer system, Macy's web site or mobile app would look like if it accepted cards from all merchants. The user can select any accepted or approved vendor name and enter the card number as form of payment on 71.

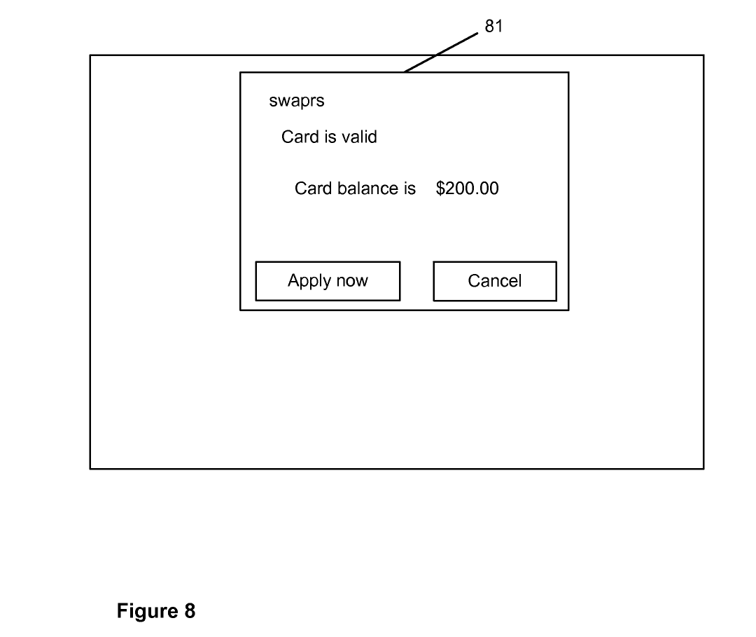

FIG. 8 illustrates the $200 Nike card being validated and the user is requested to accept the transaction and apply the balance to the purchase in 81.

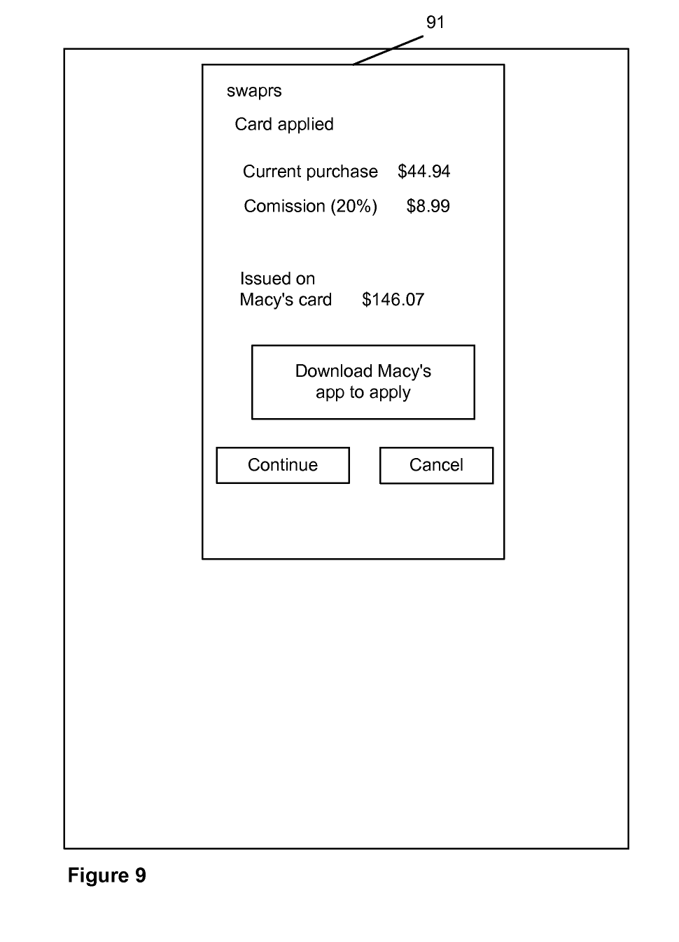

FIG. 9 illustrates the totals being shown to the user for his approval in 91. The user can accept and select to receive the balance in a Macy's card or other form of payments such as an Amex card, cash or coupon.

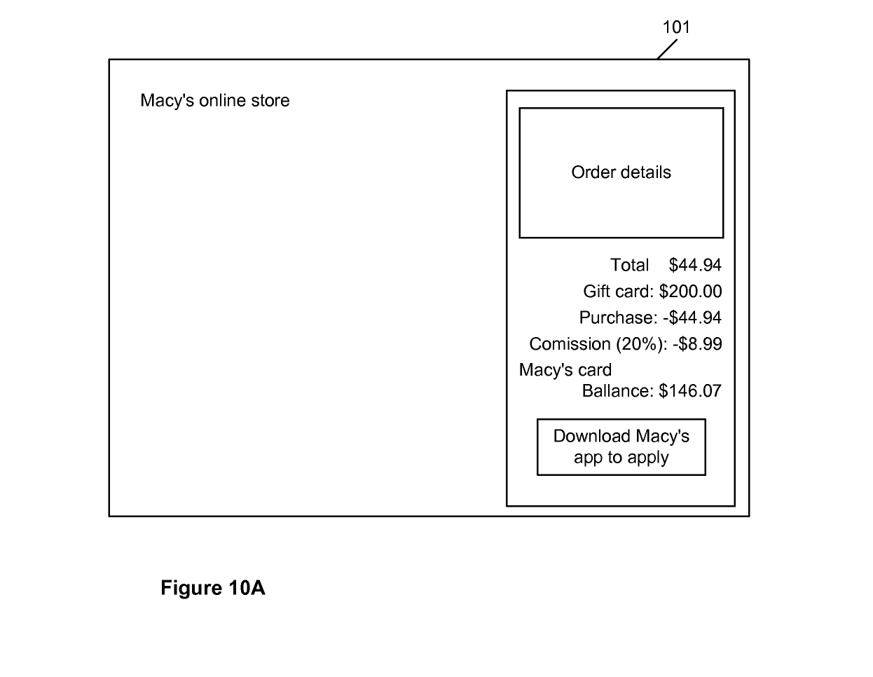

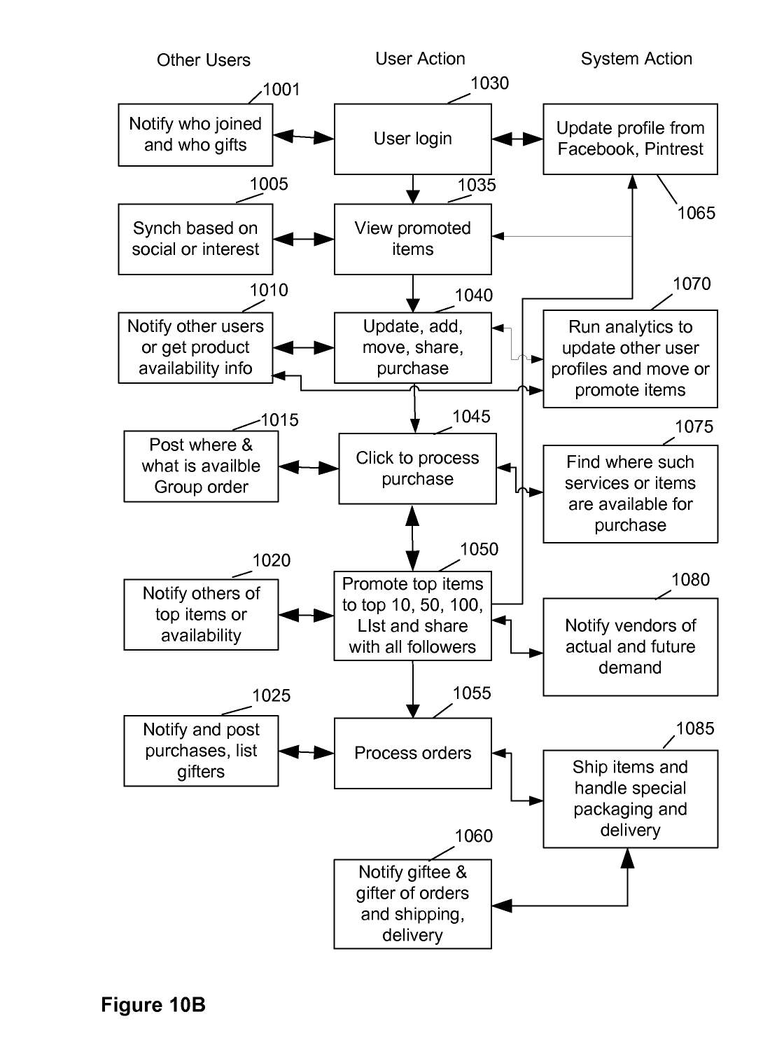

FIG. 10A illustrates the final accounting and receipt of the affected transaction based on the user options in 101 indicating total credit and exchange value provided for gift cards, miles, points or other currency or value held by the user and applied in the process.

FIG. 10B shows a flow diagram of the inventive system showing the user interaction with the system and the order by which favorite items (i.e., a trending list) system wide are selected and displayed to all users. The process is entirely based on uploads views, “likes” and orders of other users wherein the system uses an algorithm such as, for example, giving 1 point for view, 3 points for “like,” 5 points for someone uploading the same image and 10-50 points for an order based on dollar value. Different actions by different users (such as higher value for trend setter or influencers) are scored by the system for each item uploaded or marked in the system by them. User input is also used to identify where such items are available online and offline and how many of such items remain for purchase. As orders are placed other users who may not be logged in may be notified of popular items that are disappearing fast or just became available. Users login at step 1030, they can see who else joined and who is gifting in 1001, they can synch their social graph and social ranking in step 1065 and 1005. They can watch trending (or promoted) items or upload new ones in 1035. Any user profile is analyzed to compare list of trending items to the date when they uploaded such image 1070, if they are first to list and have a score that is better than any of the 100 trending items or higher trending items than any of the limited 100 existing trend setter the system will automatically act to replace one of the trend setters and be announced to the entire platform of users in step 1050. Other competing trend setters may have reached a level of 10 items which allows them to exchange any trending item with others without others voting or promoting such items in step 1065 and 1040. As purchases, “likes” and views are made the system dynamically updates the trending list and the top 100 list based on overall score in step 1050. Vendors are also notified of changes in supply or demand of any trending items so they can adjust their own purchases of inventory and the allocations they provide to the system in step 1080 and 1085. The dynamic nature of the system enables a complete self-management of users, trend setter, vendors and top trending items as the different elements of the process interact with the computer system and each other. The best trend setters rise to the top and with them the top trending items and vendors who react fastest to supply the items most coveted by users. As the system notifies all involved parties in steps 1060, 1025, 1085, 1080, 1020, 1015 the process continues with more postings, updates and orders.

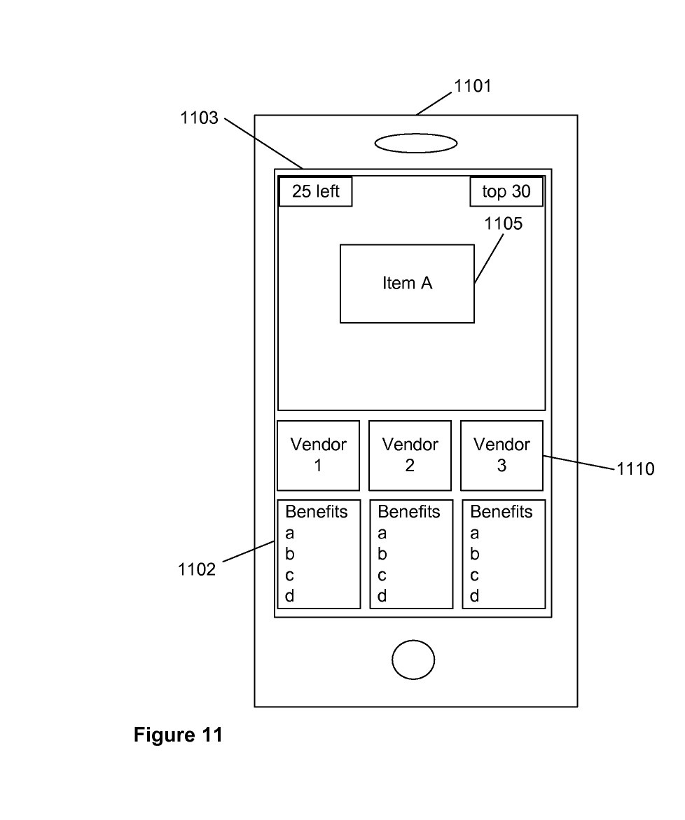

FIG. 11 is diagram of the mobile device 1101 and a user screen 1103 showing an image or video of trending Item A at 1105 the ranking of such item top 30 out of 100 and that 25 such items are left in inventory from all sellers. Under Item A Vendor 1 displays his price, store location, delivery methods supported, and other options supported by the vendor and program in 1102. A slot for vendor 3 in 1110 has not been linked to any specific vendor who sells product A so any vendor viewing the trending items can use such link by pressing “list your name” to add his inventory and sell items via the application. If there are more than one vendor the program offers vendors to list what they will pay for the listing and what they will pay for the commission for any successful sale, their entries dictate the location their listing will be given as it compares to others listed on the same page at any slot on 1110. If the number of listed parties exceeds the total slots on the page the app will enable to scroll left or right the vendors displayed to show another 3 options that match the user selections. Such vendors 1110 and payment benefits may be only displayed when a user selects or asks for more information about item A, in normal or an initial screen view such options may be hidden from the user. Under the vendors 1, 2, and 3 other benefits may be displayed, such benefits may be listed on the same page or on another screen initiated by the user. Such benefits may include benefits listed by vendors, other users or payment options associated with the user who is browsing the trending items. Benefits may include miles or rewards offered by credit card companies the user has or third parties willing to offer incentives linked to the proposed transaction. These offers help the user navigate and select the payment form and actions he is willing to take in order to benefit from the proposed offers. Such offers may require the user to provide written, video or image endorsement of the product or service to his social network or third parties upon which such promotions will be applied to his account. Third parties can list their offerings in any available slot and they may be ranked based on user popularity or fees paid to the computer system or the operator of such system.

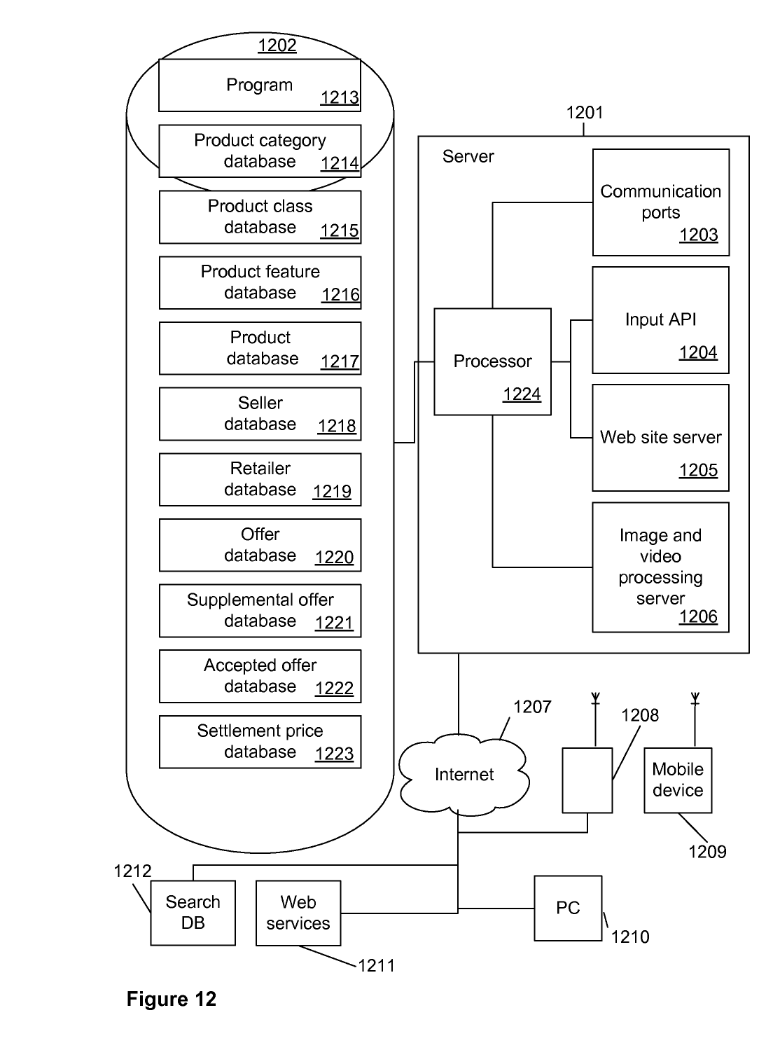

FIG. 12 is a diagram describing the servers and networks necessary to operate the inventive system. Server 1201 contains the processors 1224, memory and databases 1202 which can be same or additional databases to database 500 on FIG. 1, to interact and service outside elements of the proposed invention. The server 1201 interacts via the internet and mobile networks with users & vendors via their various devices such as PC 1210 & mobile devices 1209 and third party applications such as search engines 1212 and web services 1211. The server 1201 also interacts with Database 1202 (DB) to add and retrieve information contributed and requested by all parties. The server is responsible to combine and retrieve information from third parties and internal data sources and rank the value of each trending item added or purchased, financial benefit, credit, offer and availability of promotion, credit, feature of all listed credit cards, gift cards, store credits and other entries so a measured and consistent calculation and comparison of various offers can be made and displayed in summary to each user so they can select the most optimal payment option to choose for each transaction. For example the system may give miles earned and owned by any user 20% weight, interest charged by their credit card 25%, exchange value of a gift card user owns at 15% and company selling or buying product 10%. Such requests may be placed via dedicated communication ports 1203, internet links, Application Program Interface 1204, web sites server 1205 and other elements not shown. The main server can also process images, bar codes, videos and other inputs from users and vendors and categorize them to specific new products and services or add them to existing ones. Such categorization can also be used to serve as an image search engine.

Users of the inventive system can also access and manage their entries via connected computers 1210 for some or all the functions described. Server 1201 and database 1202 may be distributed across multiple locations or shared over many servers. Server 1201 includes a messaging bus which allows all the software and hardware components 1224, 1203, 1204 and others of the inventive system to communicate and interact with each other. As described the server 1201 is also connected to external systems, API's and databases 1211, 1212 via internet connection 1207 to enable access and interaction among the aforementioned elements to perform the tasks described.

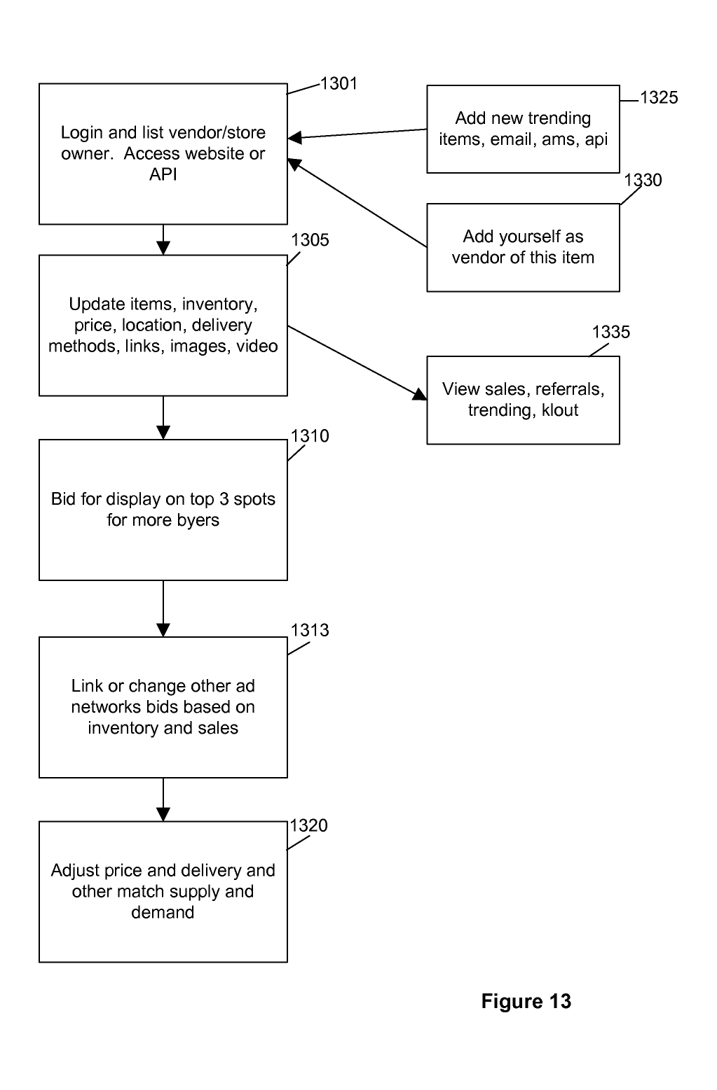

FIG. 13 is a flow diagram of how vendors interact with the system and how they select and add new items. Vendors can register with the web site connected to the hosted system or use the mobile app at step 1301 and be notified when items or companies/brands they listed are added to the trending lists via step 1325. They can also add themselves to specific items already on display as describe in FIG. 11 and step 1330 or upload images or videos of their items to be processed by the system into products and categories in step 1305. Vendors list specific companies, brands, sizes, quantities, locations of items they have in physical stores or warehouses, delivery methods they support and geographies they cover as well as other options offered by the platform in step 1320. Vendors can also update items or link to their supply chain ERP, EDI and API systems to manage such inventory in real time via steps 1315 and 1325. Vendors can bid against other vendors to be listed below any trending images or to promote one of their items to be a trending image in step 1310. The platform uses many parameters to select which vendors to display to which users so it's up to the vendors to manage how broad their exposure is based on the price they pay for the display and the process they pay as a commission for each purchase, these can be managed by step 1335 and 1315. Vendors can also narrow or expand number of displays based on delivery method, price of the items they charge and other elements. The platform can also be lined to other ad exchanges and external systems to manage ad budgets and inventory in real time based on absolute supply and demand of each item listed in step 1315.

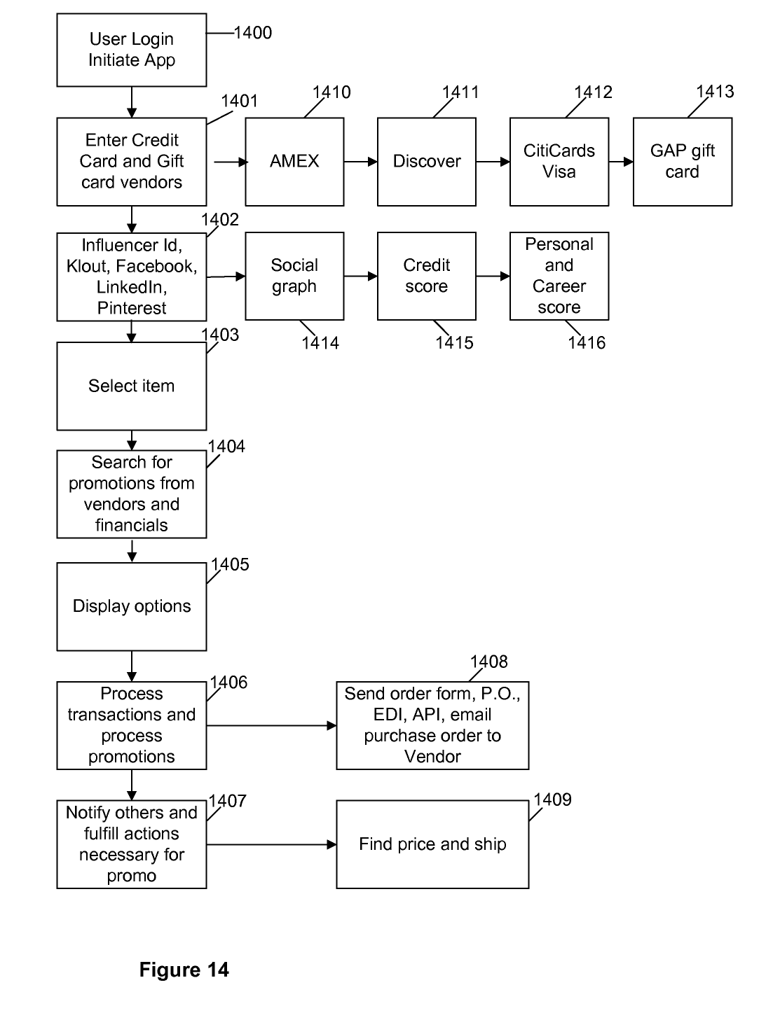

FIG. 14 is a flow diagram describing how users can login and initiate the App at Step 1400, list their payment methods 1401, and company and brand affiliations to maximize the benefits of any transaction, users may enter the companies and brands they interact with and brands of the credit cards and gift cards they own as well as specific card numbers in 1410, 1411, 1412, 1413, they may link to social and professional sites and applications at 1402 to indicate their level of influence in specific social geographies and products or services 1414, 1415, 1416 (all such verification is done by the system based on authorization by the user to access the relevant information). The system is using such indications to collect all relevant promotions, offers and benefits from third parties so when the user selects an item 1403 or service to purchase the system conducts a search for promotions from vendors and financials in step 1404 and every possible payment method is displayed with its benefits in a descending order based on its overall benefit to the user in step 1405. The system searches for what AMEX will offer versus Discover or a gift card from the GAP as well as what the seller or the vendor will be willing to do for this specific buyer based on their social and professional influence. Vendors and brands can list offers based on overall score levels managed by the system. The system helps the user navigate and accept such offers process the payment in step 1406 and take the necessary actions by writing a review and posting it, creating a video endorsement or listing an image. Upon the completion of such steps the transaction is processed and orders are issued to the vendor or seller or the brand selected.

In another embodiment the system may receive offers from the issuers of gift cards or other credits or third parties to purchase such cards at varying discounts and may solicit such card holders to sell their cards at a discount so the issuer or third party can book a profit or reverse their accounting entry for such card or credit.

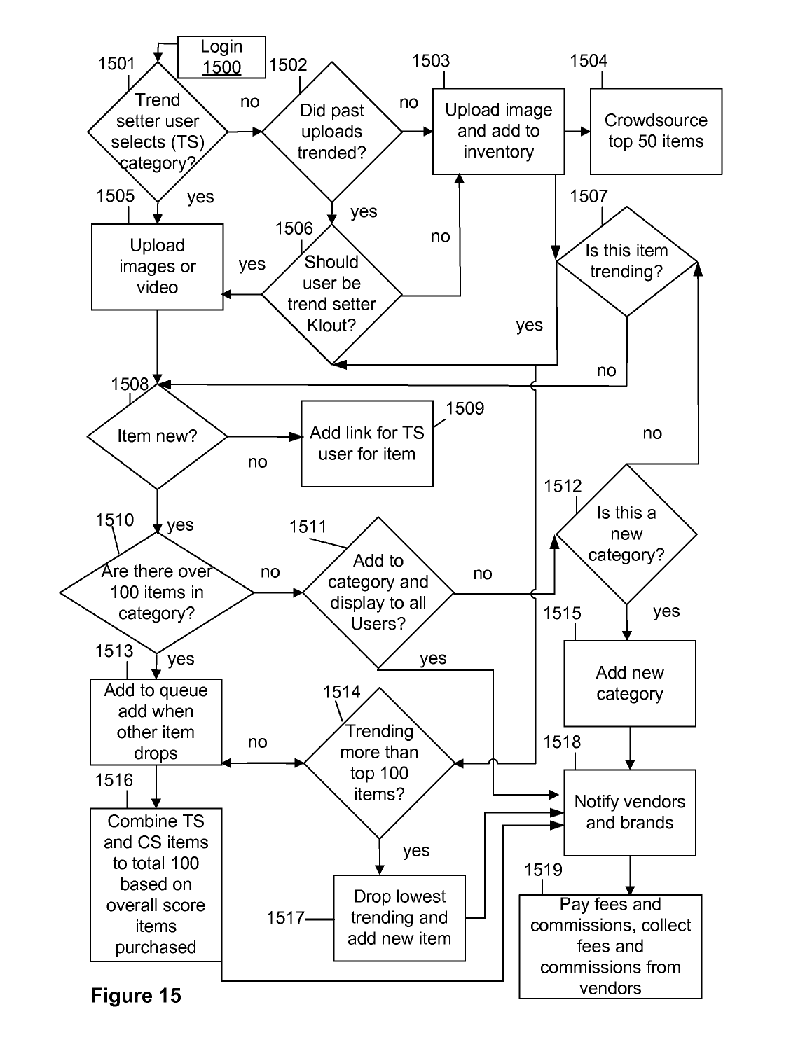

FIG. 15 is a flow diagram of the process by which users and trend setters add, manage and remove items from the top trending lists the system manages. Users log at 1500 into the application on their device or the web site linked to the system at 1501 and select a category and upload images or video on 1503 and post links to specific items on other apps or web sites at 1509. The system recognizes such users and items or requests the user to categorize or identify the listed items at 1509 & 1511. It then looks if the user is a trend setter at 1501 for that category qualified by the platform or not, if they are not the system searches past history to see if the user has a reliable history of posting early items that trended and became popular over time and should be a trend setter at 1506. The algorithm ranks all contributors and selects who should become a trend setter based on their posting history at 1504. The platform allows a limited number of items in each category so when such limit is reached a new item has to exceed the ranking or trending of other items in 1514 to take their place, as users vote items they like or purchase such items and as vendors indicate and update the inventory the platform uses dynamic algorithms to calculate and identify the trending items based on a combination of these and other factors in 1516. As categories and items are added or removed the companies, vendors and other third parties are notified so they can adjust their listings or participation in 1518. The program combines postings from trend setting users and crowd sourced posting from all other users to identify the top trending items and create trending categories in 1512 & 1513. It then allocates the available slots in each category between those two sources based on a combination of elements that indicate which group and which specific listed items has priority over others in 1517. If many users post, favor or indicate a specific item and it sells well it will be ranked higher on the list and push other listing down or out of the list completely in 1517. Trend setter may be paid a fee or commission for all products they have endorsed which may have generated sales on the platform in 1519. The platform keeps track of all such transactions and allocates such fees based on terms and condition to which the trend setters and vendors have agreed. It is contemplated that when listing sellers the application may list them based on a listing fee they agreed to pay which gives such sellers priority over other sellers, a commission they are willing to pay for each item sold or alternatively the listing may list one seller who has inventory of the trending item and a physical store location or pickup location close to the buyers current location, one seller who can offer same day delivery of such trending item and one seller who has next day delivery of such item. This type of listing or a combination of all three provides the most effective combination of the highest benefit to the buyers, sellers and the platform.

It is further contemplated that when listed trending items are sold out by all listed vendors the application indicates next to each item a number under “orders” which indicates the number of people who submitted orders that could not be fulfilled. This listing and display help encourage sellers to post their inventory to fulfill such orders and show others how popular any item is and how long is the waiting list.

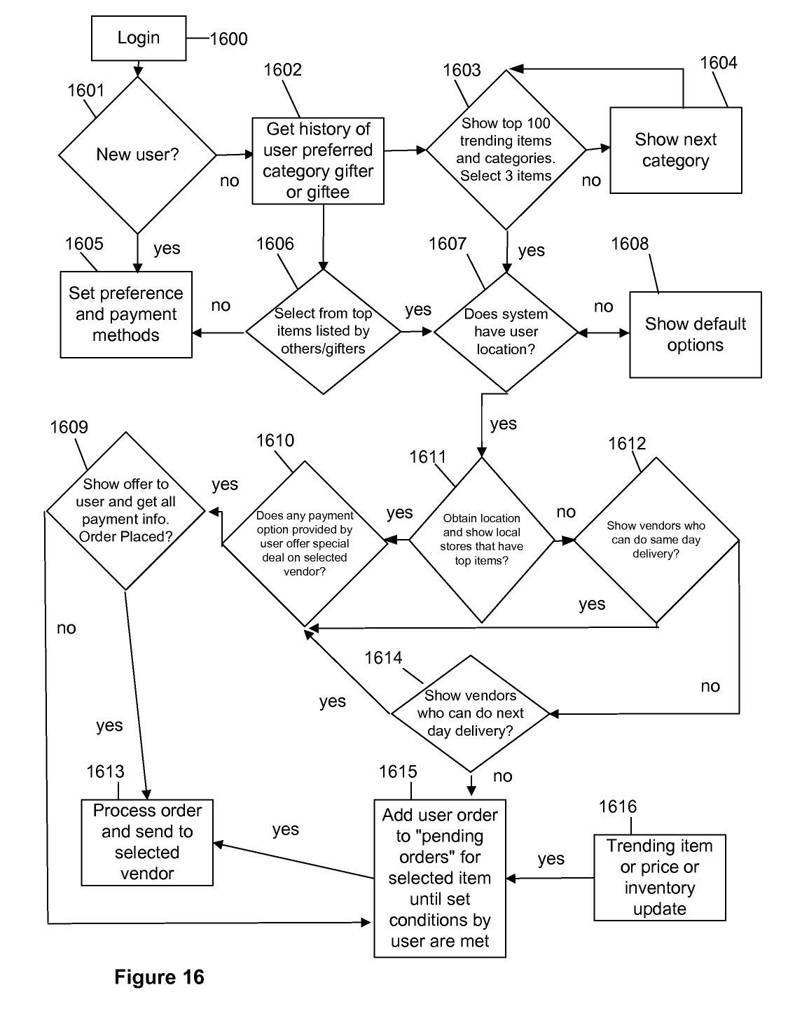

FIG. 16 is an illustration of the process flow of how items are selected ordered and transacted between system users and outside vendors who serve the computer system. After users login or initiate their app the system determines if it's a new user or existing user in 1601 if it's an existing user the system can retrieve their preferences, history, pending orders and status and also display any product category or trending list at 1602. If it's a new user the application walks the user through setup of their preferences and payment methods in their profile on 1605. Users can select any of the listed items on 1606 and if accessing via a mobile device can provide their physical location to the system server in step 1607, The system matches the location of user with a specific vendor who has indicated they have such selected item in their store and displays such info with exact store location in step 1611. Then the system proceed to compare any payment options posted by user to offerings from such vendors as they relate to the item chosen, specific vendor store selected, date, time, location or other elements that can be used to benefit the user in step 1610, if any such offer is found it is displayed to the user and processed if selected in step 1609. Upon such processing notification is sent to the selected vendor of the order and all relevant information at 1613. If no local store is found in step 1611 the system proceeds to display any vendors who have the item who can do same day or next day delivery in step 1612 & 1614. User may select one based on price, delivery, other user satisfaction and have the system process the order in step 1609 & 1613. If no vendors found or no inventory left with such vendors the order is placed as a “pending order” in step 1615 and such orders are displayed next to such trending items so other vendors can view and fulfill such orders in step 1616. As new trending items, prices and inventory information is updated by vendors the system updates and fulfills orders in step 1613.

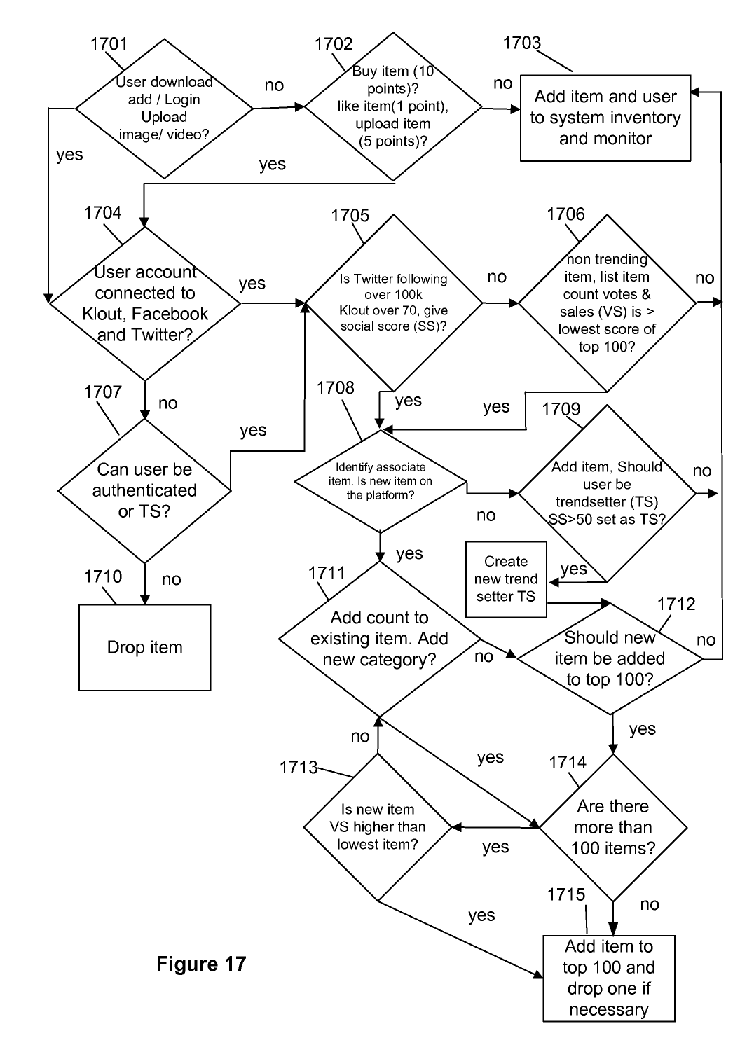

FIG. 17 is a diagram of how social score and system orders are combined to select trend setters. In 1701 users download, install or initiate the mobile app or login to the website, they can upload an image after they have been authenticated and linked to an existing account in an acceptable social platform in 1704, if no such link is established other attempts to authenticate the user are invoked in 1707 and if no success the user is dropped out of the system in 1710. After authentication users social score is determined in 1705 based on their followers, ranking, postings and other sources. If the social score is higher than existing trend setters the system proceeds to identify the uploaded item and see if it is already on the system database in 1708. If it is found the system starts a new count or adds count to the existing items or initiates a new category in 1711. If the count is higher than existing trending items by calculating the votes and sales in 1713 it is added to the top trending list in 1715. If the new user in 1705 does not have a high social score (SS) his item is added to the non trending list in 1706 and monitored in 1703. If it then starts trending it follows the process of other items in 1709 and the user can become a trend setter if enough votes and purchases are made and it makes it to the top trending list. As purchases and votes are made in 1702 the system monitors the profile of such buyers in 1704 and gives points based on their influence. As the number of items increases step 1714 monitors and sets the parameters necessary to get into any category and on any list such info can be published or viewed by users.

An embodiment of the invention includes a computer implemented method for enabling users and merchants to accept payments from third party holders of financial credits such as gift cards and coupons comprising the steps of (i) receiving, by a server having a processor and a memory, an image file of a gift card or coupon of a first user, identification of the gift card or coupon, and an issuing party of the gift card or coupon card; (ii) processing by the server the image file and validating the issuing party and balance on the credit card or coupon with the issuing party; (iii) indicating by the server to the first user the balance on the credit card or coupon; (iv) transferring by the server an amount from the credit card or coupon of the first user to an account of a second user and debiting the amount on the credit card or coupon with the issuing party.

In another embodiment, the method issues new card or payment to such user or merchant for the full or partial remaining balance on the affected transaction. This can be done on a web site, mobile app, in person in store. Some elements can be done on the app and others on the server by third party API.

In another embodiment, the method enables users to pay for any merchandize or services on any portal, app or store front with credits from any vendor and other offers made by the system which when combined provide for lower prices for selected merchandize and services.

It allows users to select and indicate products they would like to buy in their profiles from a list of top trending items. It also allow users to mark the price they will be willing to pay for such products or select between several sellers who offer such items for sale.

In another embodiment, the system conducts searches and combines different discounts and offers from third parties to try and match or get a better price than the one indicated by user. The system also offers users deals that may combine several unrelated offers from unrelated parties for any selected item. Upon user accepting such offer system to process the transaction and any related parts necessary to affect the price quoted to user. The system effects settlement with all related parties after the completion of such transaction.

In another embodiment, the method enable users who are members of a social group to indicate what and to whom they would like to issue a gift (i.e., Gifters) to another by selecting others in the social group or inviting them to join such group. It further enables users who are members of such social group or were invited to join such group to select any item they would like to buy from a list of trending items or sub list selected for them online (i.e., Giftee) list such items on a portal and invite others to see such items. It then notifies Gifters of such selections and allow them to select final item they would like to purchase, notifies Giftees of selected gift, processes payment charging the Gifter and apply any special discounts or offers by the system

It is contemplated that the Giftee makes the selection of final item.

It is contemplated the Gifter is enabled to pay for such products or services with any credit including any merchant gift card.

In another embodiment, there is provided a social network of users who share selections of items and gifts in a social web portal and mobile applications. Users are enabled to comment on selections of other users and add items to such selections, select items and the price at which they will be willing to gift to others

In another embodiment, a computer system which collects special offers from third parties and vendors and matches such offers to lower the purchase price of selected items so they will pass the price limit indicated by users, submits such items or services to the selected users, processes such transactions and applying payments and necessary processing steps to affect such transactions.

In another embodiment, there is provided a computer program and platform that works with a mobile app to enable users to enter payment method in the form of gift cards, credit cards and brands they hold or have accounts with and use the collected benefits and incentives offered by such vendors to rank in priority which of these cards should be used to pay for any transaction for a product or a service.

In another embodiment, there is provided a computer application residing on a mobile phone which enables users to view trending items from a limited group of items and display several vendors who offer such item for sale. The application dynamically displaying such vendors to each user based on user location, seller store location, item price and delivery method as well as user social influence. It is contemplated that a display is provided based on price and commission the vendor agreed to pay to the platform.

It is further contemplated that the system ranks trending items contributed by users into categories and manufacturer brands, identify vendors who sell such items, notify such vendors of the fact such items are trending, enable vendors to list their items for sale next to such trending items, display to users selective vendors which can deliver specific items to the location and price defined by the users. Display sellers based on listing fees and sales commissions they agreed to pay for each sale.

It is contemplated a group of users use a mobile device to list and rank items to view and promote all items into a select group of trending items, enable such trending items to be selected via algorithmic calculation based on crowd sourced score that combines how many users posted such items, “liked” such items, bought such items and endorsed such items, combine trending items sourced by selected and approved trend setter with crowd sourced trending items selected by users.

In another embodiment, there is provided a computer and database program with an image based search engine which allows users to upload image and video files, identify specific items on such images and describe such images from an existing list of categories, and a program which processes all such uploaded information and matches it to an existing database of images and categories and provides a result to the user which indicates where such items can be found at what price and what availability.

In another embodiment, there is provided a computer application which upon user selection displays and links specific item that is trending with specific vendors who offer it for sale and benefits of using payment methods available from a variety of credit cards and accounts held by the user, enables such user to select the vendor and payment method that best matches the need of the user, enables user to indicate which credit cards and gift cards accounts he has (without providing account numbers), identifies the specific affiliation or brand of a card (e.g, Citicard, American Airlines Visa)

When a transaction is presented as part of a purchase path, checkout basket or manual entry on an app check with a central database if any such purchase qualifies for any special discount or promotion offered by any such card, present such options to the user and let them select the payment method, take whatever necessary steps to enable the promotion as described. When trending items listed are sold out by all listed vendors the application indicates next to each item a number under “orders” which indicates the number of people who submitted orders that could not be fulfilled. This listing and display helps encourage sellers to post their inventory to fulfill such orders and shows others the popularity of any item and the length of the waiting list.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer implemented method for enabling users and merchants to accept payments from third party holders of financial credits such as gift cards and coupons comprising the steps of:
receiving, by a server having a processor and a memory, an image file of a gift card or coupon of a first user, identification of the gift card or coupon, and an issuing party of the gift card or coupon card;
processing by the server the image file and validating the issuing party and balance on the credit card or coupon with the issuing party;
indicating by the server to the first user the balance on the credit card or coupon; and
transferring by the server an amount from the credit card or coupon of the first user to an account of a second user and debiting the amount on the credit card or coupon with the issuing party.
